(19) United States
(12) Patent Application Publication
(10) Pub. No.: US 2008/0155551 A1
(43) Pub. Date: Jun. 26, 2008

(54) Apparatus and computer program product for managing resource

(75) Inventors: Hideki Yoshida, Tokyo (JP); Nobuo Sakiyama, Kanagawa (JP)

Correspondence Address: NIXON & VANDERHYE, PC, 901 NORTH GLEBE ROAD, 11TH FLOOR, ARLINGTON, VA, 22203, US

(73) Assignee: Kabushiki Kaisha Toshiba, Tokyo (JP)

(21) Appl. No.: 11/822,935

(22) Filed: Jul. 11, 2007

(30) Foreign Application Priority Data
Dec. 26, 2006 (JP) 2006-349013

(51) Int. Cl. G06F 9/46

(52) U.S. Cl. 718/104

(57) ABSTRACT

In an apparatus for resource management, a resource bidding unit calculates a bid price indicating a virtual price of a resource for each of application programs to consume or supply within a predetermined unit-time, and makes a bidding by inputting the calculated bid price. A bidding management unit allocates a resource per unit-time to each of the application programs based on the bid price input by the resource bidding unit. Moreover, the resource bidding unit determines a state of an application program whether active or inactive, and calculates the bid price to allocate the resource preferentially to an active application program rather than an inactive application program.

### CROSS-REFERENCE TO RELATED APPLICATIONS

This application is based upon and claims the benefit of priority from the prior Japanese Patent Application No. 2006-349013, filed on Dec. 26, 2006; the entire contents of which are incorporated herein by reference.

### BACKGROUND OF THE INVENTION

1. Field of the Invention

The present invention relates to an apparatus and a computer program for managing a resource for each of a plurality of application programs to consume or supply within a unit-time.

2. Description of the Related Art

Conventionally, so-called real time systems with sensors are widely used. For example, in a field of transport equipment, such as ships and vessels, aircrafts, and automobiles, a sensor information system is used that grasps a surrounding situation, and presents information about the grasped situation on screen display or using other methods to a user. Usually, a sensor information system in a case of a vessel includes a plurality of sensors, such as a radar, a sonar, an infrared sensor, and camera; recognizes a surrounding situation by analyzing signals from one or more of the sensors depending on a phase; and displays a recognition result on a screen. The information about a surrounding situation is helpful for a safe navigation of the vessel.

In such a system in the field of transport equipment, the screen display should be renewed within a certain time to notify a user of a recognized surrounding situation. Otherwise the user cannot grasp the surrounding situation promptly and, as a result, may face at risk of bringing about an accident, such as a collision. For this reason, the system has to be a real time system, signal processing based on sensor signals is required to be processed in real time to satisfy a certain time restriction.

Conventionally, in such a real time system for performing signal processing of a plurality of sensor signals, each of the signals is generally processed in an independent sub-system. The reason for this is because designing and development of a sensor information system that satisfies a certain time restriction can be facilitated by performing resource allocation on each sub-system, for example, by individually providing each sub-system with a computer resource required for signal processing of each of signals, such as a central processing unit (CPU), and running a real time operating system (OS) in each sub-system.

However, such a method, in which independent sub-systems are individually created for respective signals, has a problem that a sub-system responsible for a signal cannot satisfy a certain time restriction on processing of the signal, or cannot perform the processing at all, if an over load or a malfunction of an element in the sub-system occurs in the sub-system, even though a computer resource in another sub-system has a margin.

Therefore, to cope with such an over load or a malfunction by the sub-system alone, each of sub-systems has to have configuration that includes a certain extra margin in a function, a processing capacity, and the like. However, to implement such configuration with an extra margin, enormous hardware equipment is required, so that costs of equipment, capacity, and power consumption are each increased. As a result, a situation occurs that commercial and technical feasibility of the sensor information system declines.

For this reason, in a field of aircrafts, there is a demand to construct a sensor information system with relatively small hardware equipment by integrating signal processing of a plurality of signals into a single computer system. Generally, such a system is implemented as a distributed system in which a plurality of nodes are connected to each other with a network, and each of the nodes includes one or more processor, memory, and input-output device.

However, if processing of a plurality of signals are simply integrated into one system, and if there are a more critical signal and a less critical signal on a certain phase during the processing of signals, there is a possibility that a rise in the load of processing of the less critical signal may affect a time restriction on processing of the more critical signal.

Theoretically, such a problem can be solved, if the whole system runs a single real time OS, and manages scheduling in real time as a whole. However, if the single OS controls the system including several processors, the scheduling becomes very complicated in reality. Consequently, in some cases, it takes a long time to process the scheduling, which makes it difficult to obtain adequate performance to satisfy a certain time restriction. An even more serious problem is that if nodes are connected to each other via a network through which real time performance is not strictly guaranteed, real time scheduling across nodes cannot be carried out at all.

Conventionally, as a method of performing resource allocation in a distributed system in a distributed manner in general, a resource allocation method by bidding has been studied (see, for example, Andrew Byde, Mathias Salle, and Claudio Bartolini, Market-Based Resource Allocation for Utility Data Centers, HP Labs Technical Report HPL-2003-188, 2003).

The resource allocation method by bidding is that a distribution of a resource, such as a CPU time, is carried out by bidding per unit-time or task. In other words, each of application programs prices a resource, and requests an allocation of the resource, and then the allocation is determined such that an application program that has priced the resource at the highest price receives the allocation of the resource and runs. A currency to be used in the bidding is an indicator to quantify to what extent an application program matters to a user on a phase, that is, a virtual currency unnecessary to be linked to a real currency. A characteristic of the method is that a behavior of each of modules in the system for maximizing a profit brings about an improvement in efficiency of the whole system, where the profit is obtained by subtracting an amount of the currency paid by the module from an amount of the currency received by the module.

Using the bidding method, an application program that is to perform processing of a material sensor signal is allowed to make a high bid price, so that resource allocation appropriate to materiality of a sensor signal on each phase can be achieved. Moreover, there is an advantage that it is easy to perform distribution processing of the resource allocation, because bidding processing can be performed in a distributed manner by performing bidding processing on each of the nodes for a resource for the node.

In a simple model of resource allocation, only a physical resource, such as a CPU time, is a resource; a computer program, such as an OS or middleware is a supplier; and an application program is a consumer. However, in an actual system, more sophisticated bidding is sometimes performed based on a more complicated resource allocation model.

Particularly, if resource allocation in a distributed system is performed in a bidding method, a more sophisticated resource allocation model, so-called supply chain model, is sometimes used in some cases (for example, William E. Walsh and Michael P. Wellman, Efficiency and Equilibrium in Task Allocation Economies with Hierarchical Dependencies, in Proceedings of the Sixteenth International Joint Conference on Artificial Intelligence, 1999).

The model is imitating a supply chain in the manufacturing industry and the distribution business. In the model, a concept of a producer is introduced in addition to the supplier and the consumer. The producer buys a resource form another party and produces a resource to sell to another party. Additionally to a physical resource, data created by the producer is treated as a resource.

By introducing the concept of a producer, a bidding model can deal with distribution of processing to a plurality of nodes, and an application program that performs pre-processing of data to be used by another application program. The supplier, the consumer, and the producer do not mean a natural person or a legal person, but mean respective module programs implemented on a software program within the system.

In the supply chain bidding, the same application programs are caused to run on the different nodes, and the application programs sell data created by themselves in bidding, so that processing can be assigned to a plurality of nodes. If more than one nodes make bids at the same bid price, generally, a contract volume is equally distributed to such nodes, or an arbitrary node is selected from the nodes, and caused to win a successful bid.

However, in such a method, despite that only a few of the nodes can perform processing, processing is sometimes distributed to many of the nodes. This causes a problem that some application program is activated even in a node in which the application program originally does not need to be activated, and the CPU time is consumed for activation of the application program. Moreover, to compensate an increase in the quantity of the nodes, the consumption volume of the main memory and the cache memory for executing application programs in the whole system is increased, which is also a problem.

Particularly, in a real time system as described above, resource allocation needs to be performed per unit-time to perform processing while satisfying a time restriction. In such a case, compared with a case where resource allocation is performed per unit that is between activation and termination of a task, a cost of the CPU time for activation of an application program is relatively high, thereby causing a larger influence.

### SUMMARY OF THE INVENTION

According to one aspect of the present invention, an apparatus for resource management that determines allocation of a resource for each of a plurality of application programs to consume or supply within a predetermined unit-time based on a bidding, the apparatus includes a discriminating unit that discriminates between an active application program and an inactive application program among the application programs; a bid-price calculating unit that calculates a bid price indicating a virtual price of the resource in the bidding to be a value at which the resource is to be preferentially allocated to the active application program rather than the inactive application program; and a bidding management unit that allocates the resource to each of the application programs based on the bid price calculated by the bid-price calculating unit.

According to another aspect of the present invention, a computer program product having a computer readable medium including programmed instructions for determining allocation of a resource for each of a plurality of application programs to consume or supply within a predetermined unit-time based on a bidding, wherein the instructions, when executed by a computer, cause the computer to perform discriminating between an active application program and an inactive application program among the application programs; calculating a bid price indicating a virtual price of the resource in the bidding to be a value at which the resource is to be preferentially allocated to the active application program rather than the inactive application program; and allocating the resource to each of the application programs based on the bid price calculated in the calculating.

### BRIEF DESCRIPTION OF THE DRAWINGS

FIG. 1 is a block diagram of hardware configuration of a sensor information system according to a first embodiment;

FIG. 2 is a functional block diagram for explaining part relevant to resource management in software configuration of the sensor information system shown in FIG. 1;

FIG. 3 is a schematic diagram for explaining relation between supply and consumption of resources according to the first embodiment;

FIG. 4 is a functional block diagram of configuration of a resource bidding unit and a bidding management unit shown in FIG. 2;

FIG. 5 is a flowchart of an exemplary processing performed by a bid-price calculating unit of a supplier shown in FIG. 3;

FIG. 6 is a flowchart of an exemplary processing performed by a bid-price calculating unit of a producer shown in FIG. 3;

FIG. 7 is a flowchart of an exemplary processing performed by a bid-price calculating unit of a consumer shown in FIG. 3;

FIG. 8 is a schematic diagram for explaining that bidding processing is to be performed only a predetermined number of times according to the first embodiment;

FIG. 9 is a schematic diagram for explaining a unit-time of processing;

FIG. 10 is a schematic diagram for explaining an example of bid information for physical resources according to the first embodiment;

FIG. 11 is a schematic diagram for explaining an example of bid information for data according to the first embodiment;

FIG. 12 is a flowchart of an exemplary processing performed by a successful-bidder determining unit of a physical resource manager shown in FIG. 3;

FIG. 13 is a flowchart of an exemplary processing performed by a successful-bidder determining unit of an information displaying application program shown in FIG. 3;

FIG. 14 is a flowchart of an exemplary processing performed by a round-repeat management unit shown in FIG. 4;

FIG. 15 is a table of an example of changes in volumes and values of bids and successful bids for CPU use rates as rounds go on according to the first embodiment;

FIG. 16 is a table of an example of changes in volumes and values of bids and successful bids for data as rounds go on according to the first embodiment;

FIG. 17 is a flowchart of an example of a bid dividing process according to the first embodiment;

FIG. 18 is a schematic diagram for explaining an operation example according to the first embodiment when nodes are in normal operation;

FIG. 19 is a schematic diagram for explaining an operation example according to the first embodiment when a node malfunction occurs;

FIG. 20 is a functional block diagram for explaining part relevant to resource management in software configuration of a sensor information system according to a second embodiment;

FIG. 21 is a schematic diagram for explaining an example of an application-program bid-information table according to the second embodiment;

FIG. 22 is a schematic diagram for explaining an example of a setting information table according to the second embodiment;

FIG. 23 is a flowchart of a general flow of a bid dividing process according to the second embodiment;

FIG. 24 is a schematic diagram for explaining an operation example according to the second embodiment when nodes are in normal operation; and

FIG. 25 is a schematic diagram for explaining an operation example according to the second embodiment when a node malfunction occurs.

### DETAILED DESCRIPTION OF THE INVENTION

Exemplary embodiments of an apparatus and a computer program product for managing a resource according to the present invention are explained below in detail with reference to the accompanying drawings.

To suppress a new activation of an application program by a resource allocation method based on a market mechanism, a conceivable approach to assigning processing is in accordance with a policy to make the quantity of nodes to be assigned with processing of an application program as few as possible.

However, if the assignment policy is attempted to be achieved by a general method, for example, by controlling the quantity of active application programs in the whole system across the nodes, centralized control in the whole system is required. Such method is against an intention of introduction of the market mechanism to assign processing without centralized control.

Therefore, as a method of achieving such assignment based on the market mechanism without centralized control, an approach to reflecting the assignment policy as a cost in bidding is conceivable. In other words, it is adequate that a node without active application program makes a bid at a selling price higher by the cost than a price bid by a node assigned with an active application program.

According to the method, only when a new activation of the application program is required more than the cost, a bid from the application program in the inactive-application-program node is accepted successfully, and the application program is activated, so that new activations are minimized. A case of a malfunction of a node, and a case where an over load occurs on a node assigned with an active application program are envisaged as a situation where a new activation of an application program is required.

In the method, a key is a mechanism through which bidding takes place by a node without active application program. Because it is assumed in the method that an application program is to bid as a bidder, the application program in the inactive-application-program node cannot participate in bidding.

For this reason, a resource management apparatus according to the first embodiment employs the following method: an application program that participates in bidding is separated into a logic processing unit and a resource bidding unit; the logic processing unit performs processing such as signal processing, which is an intrinsic function of the application program; the resource bidding unit participates in bidding; and only the resource bidding unit is activated. The logic processing unit is separately activated, when the resource bidding unit in the inactive-application-program node wins bidding successfully.

According to the first embodiment, because implementation of an application program by client server system is assumed, the application program is implemented as a server, and performs processing in response to a call from a client. In the first embodiment, a method is described below that an application program directly performs communication processing in accordance with Transmission Control Protocol/Internet Protocol (TCP/IP). However, implementation is also available in a method that the communication processing is performed by distributed middleware, such as Common Object Request Broker Architecture (CORBA).

1. Hardware Configuration of System

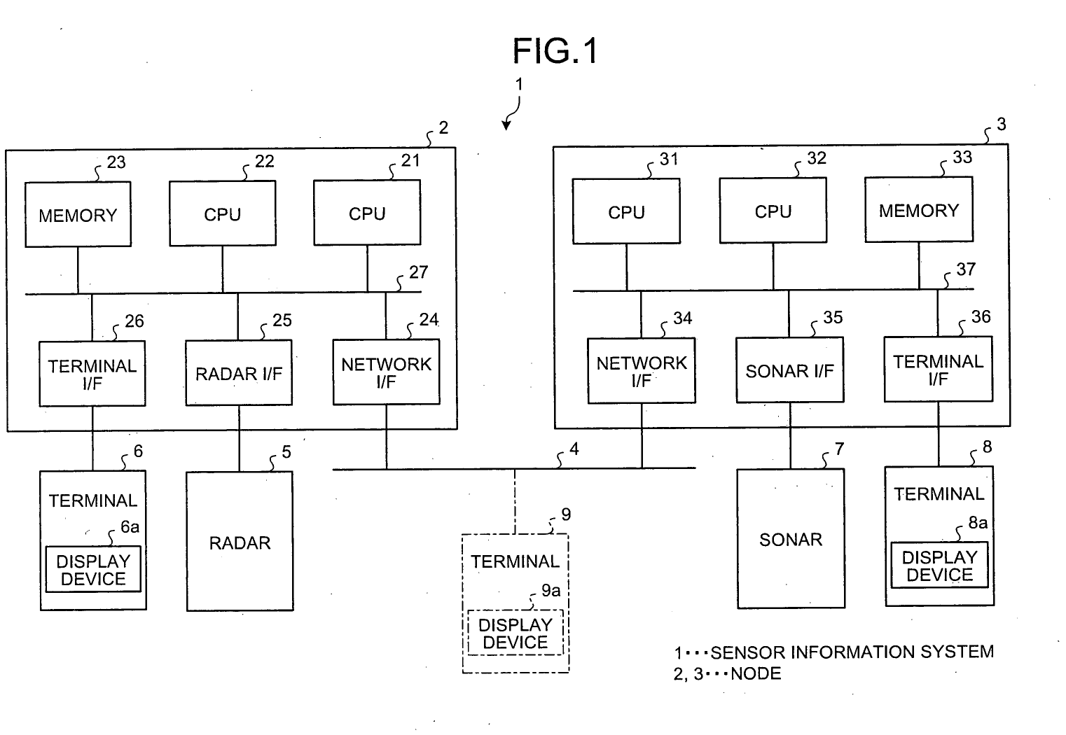

Hardware configuration of a system according to a first embodiment is explained below with reference to FIG. 1. A sensor information system according to the first embodiment is to be used for a ship or a vessel, or an aircraft. The sensor information system is configured in the first embodiment to notify a crew a surrounding situation as sensor information based on sensor signals from a radar and a sonar. The sensor information system is a so-called real time system. Particularly, if a dangerous obstacle is detected, the sensor information system notifies a crew the sensor information in screen display immediately, i.e., within a predetermined time after the detection. The real time system is a system such that certain processing is performed within a predetermined time, for example, processing of displaying certain sensor information on the screen of a display device is performed within one second after a sensor signal is detected.

A sensor information system 1 is configured to include a plurality of nodes, which are two nodes 2 and 3 in FIG. 1, connected to each other via a network 4. The node 2 is connected to a radar 5 and a terminal 6. The node 2 is a computer device that performs certain signal processing, and displays a result of the signal processing onto the screen of a display device 6a of the terminal 6. As described later, the node 2 includes a signal processing application program (hereinafter, an application program is sometime simply referred to as an application in some following description) that performs certain signal processing based on respective signals from the radar 5 and a sonar 7, and an information displaying application program to display a result of the signal processing relevant to the signal from the radar 5 onto the display device 6a.

The node 3 is connected to the sonar 7 and a terminal 8. The node 3 is a computer device that performs certain signal processing, and displays a result of the signal processing onto the screen of a display device 8a of the terminal 8. As described later, the node 3 includes a signal processing application program that performs certain signal processing based on respective signals from the sonar 7 and the radar 5, and an information displaying application program to display a result of the signal processing relevant to the signal from the sonar 7 onto the display device 8a.

In addition, as described later, the sensor information system 1 is configured such that a sensor signal from the radar 5 is transmitted to the node 3 via the network 4, and a sensor signal from the sonar 7 is also transmitted to the node 2 via the network 4.

The node 2 displays radar information onto the screen of the display device 6a, so that the node 2 can present information about the sensor signal from the radar 5 to a user in real time. Likewise, the node 3 displays sonar information onto the screen of the display device 8a, so that the node 3 can present information about the sensor signal from the sonar 7 to the user in real time.

Thus, in the first embodiment, information processing of sensor information from two sensors, namely, the radar 5 and the sonar 7, are performed by the two nodes 2 and 3, and the processing results, namely, the radar information and the sonar information, are displayed on the respective screens of the display devices 6a and 8a, respectively. For example, in a case of a vessel, if an obstacle is detected by the radar 5, information about the obstacle, such as locational information, is displayed on the screen in real time as the sensor information.

The node 2 is configured to include two central processing units (CPUs) 21 and 22, a memory 23, a network interface (network I/F) 24, a radar interface (radar I/F) 25, and a terminal interface (terminal I/F) 26, which are connected to each other via a bus 27.

Likewise, the node 3 is configured to include two CPUs 31 and 32, a memory 33, a network I/F 34, a sonar interface (sonar I/F) 35, and a terminal I/F 36, which are connected to each other via a bus 37.

The buses 27 and 37 can be wiring between circuit boards of the nodes, wiring on the circuit boards, or internal wiring inside chips. The network I/Fs 24 and 34 are interfaces to connect the nodes 2 and 3 to the network 4, respectively. The terminal I/Fs 26 and 36 are interfaces to connect the nodes 2 and 3 to the terminals 6 and 8, respectively. Via the radar I/F 25, the node 2 is connected to the radar 5. Via the sonar I/F 35, the node 3 is connected to the sonar 7.

The network 4 can be a network that ensures a real time performance, or a network via which a real time performance is not guaranteed, such as Ethernet®.

In FIG. 1, the radar 5 and the sonar 7 are connected to the nodes 2 and 3, respectively, via the respective interfaces. However, each of the radar 5 and the sonar 7 can be configured to include a built-in network interface and to be directly connected to the network 4. In such case, respective signals from the radar 5 and the sonar 7 are transmitted to the nodes 2 and 3, respectively, via the network 4.

Furthermore, in the above explanation, the terminals 6 and 8 are connected to the nodes 2 and 3, respectively, however, as presented with dashed lines in FIG. 1, another terminal 9 further connected to the network 4 can be provided instead of, or additionally to, the terminals 6 and 8. If the terminal 9 is provided instead of the terminals 6 and 8, the radar information and the sonar information are to be displayed on a display device 9a of the terminal 9. If the terminal 9 is provided additionally to the terminals 6 and 8, it can be configured to display the radar information and the sonar information only on the display device 9a, or additionally on the display device 9a.

In addition, although it is not shown in the figure, the sensor information system 1 includes one or more terminals each of which includes a display device, a keyboard, and the like, and the terminal is connected to either the node 2 or 3.

2. Software Configuration of System

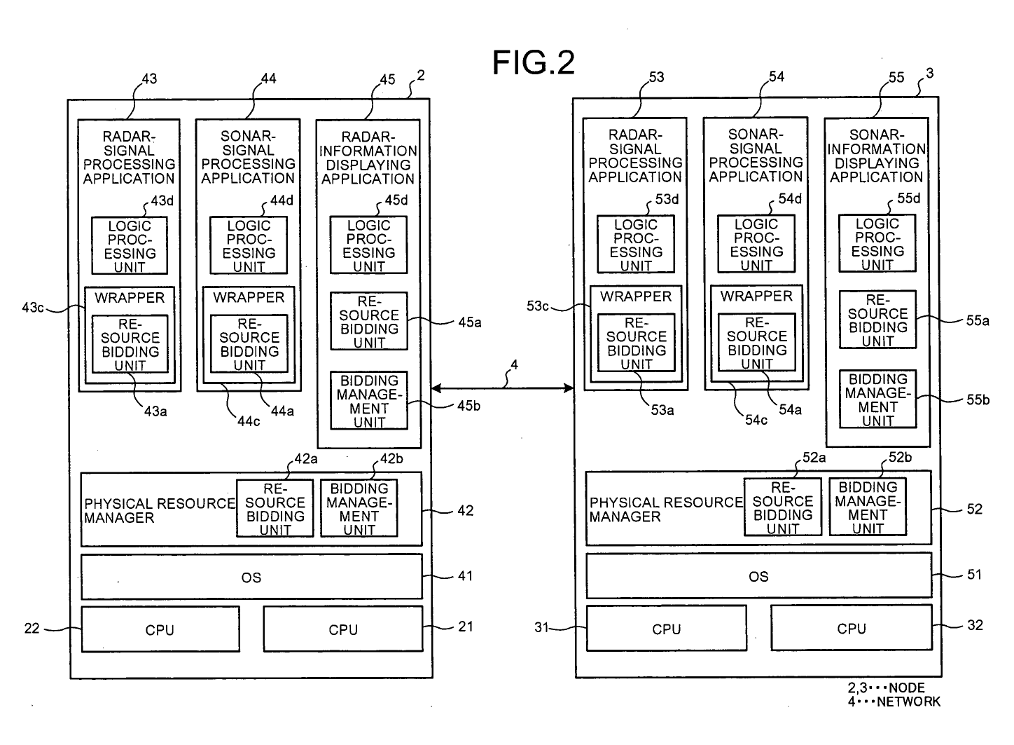

Software configuration in the nodes 2 and 3 is explained below with reference to FIG. 2.

The nodes 2 and 3 are application-program executing devices that execute signal processing of a radar signal and a sonar signal, and displaying processing of radar-information display or sonar-information display, and also a resource management apparatus that manages resources, such as a CPU time. In other words, the nodes 2 and 3 perform the signal processing based on a radar signal and a sonar signal, and perform sensor information processing for displaying a result of the signal processing onto the display devices 6a and 8a in real time as the radar information or the sonar information, and moreover, perform resource management for such real-time processing of the sensor information. In that sense, the nodes 2 and 3 are configured as a resource management apparatus, which is a computer device principally implemented by a software program that runs to execute an application program on each of the nodes.

In the node 2, the two CPUs 21 and 22, which are hardware, run an operating system (OS) 4. The OS 41 is an OS applicable to a multiprocessor, and can be, for example, Windows®, or Linux. On the OS 41, a physical resource manager 42 is provided, which manages a CPU time as a resource.

Via the physical resource manager 42, three application programs run on the OS 41: namely, a radar-signal processing application 43, which is a radar-signal processing unit; a sonar-signal processing application 44, which is a sonar-signal processing unit; and a radar-information displaying application 45, which is a radar-information displaying unit.

Similarly in the node 3, the two CPUs 31 and 32, which are hardware, run an OS 51. The OS 51 is also applicable to a multiprocessor. On the OS 51, a physical resource manager 52 is provided, which manages the CPU time as a resource.

Via the physical resource manager 52, three application programs run on the OS 51, namely, a radar-signal processing application 53, a sonar-signal processing application 54, and a sonar-information displaying application 55.

When executing each of the application programs, the physical resource managers 42 and 52 perform certain processing in response to a bid from each of the application programs as described later, and manages the CPU time to cause the CPUs to execute each of the application programs for a portion of the CPU time won by each of the application programs in bidding.

In each of the nodes in which the resource management apparatus operates, software programs and hardware are managed by one operating system, namely, the OS 41 or the OS 51. In the first embodiment, two CPUs are present in each of the nodes. Even if a plurality of CPUs is present in a node, an OS applicable to a multiprocessor runs, and the OS wholly manages resources in each of the nodes. Management of the physical resource is carried out by the physical resource managers 42 and 52, each of which is implemented as middleware that runs on each OS. The physical resource managers 42 and 52 can be implemented as an internal function in the OS.

The resource management apparatus includes a plurality of resource bidding units, a plurality of bidding management units, and a plurality of logic processing units. Specifically, in the node 2, the physical resource manager 42 includes a resource bidding unit 42a and a bidding management unit 42b.

The radar-signal processing application 43 includes a wrapper 43c that includes a resource bidding unit 43a, and a logic processing unit 43d. The sonar-signal processing application 44 includes a wrapper 44c that includes a resource bidding unit 44a, and a logic processing unit 44d. The radar-information displaying application 45 includes a resource bidding unit 45a, a bidding management unit 45b and a logic processing unit 45d. Likewise, in the node 3, the physical resource manager 52 includes a resource bidding unit 52a and a bidding management unit 52b. The radar-signal processing application 53 includes a wrapper 53c that includes a resource bidding unit 53a, and a logic processing unit 53d.

The sonar-signal processing application 54 includes a wrapper 54c that includes a resource bidding unit 54a, and a logic processing unit 54d. The sonar-information displaying application 55 includes a resource bidding unit 55a, a bidding management unit 55b and a logic processing unit 55d. In other words, each of the resource bidding units 42a, 43a, 52a, 53a, and the like, is provided inside a processing unit that is a module that supplies or consumes a resource (the physical resource managers 42 and 52, the radar-signal processing application 43, the sonar-signal processing application 44, and the like, in the first embodiment).

It is possible that the resource bidding units are provided in only some of the application programs. For example, the configuration can be such that the resource bidding unit is not provided in an application program that does not consume a resource substantially to omit participation in bidding, by contrast, the resource bidding unit is provided only in an application program that consumes a large volume of resource. In such case, the resource to be consumed by the application program not participating in bidding should be separately allocated at a fixed volume including a certain extra margin.

On the other hand, the bidding management unit can be provided to each of the nodes as a single unit covering the whole nodes, otherwise, a plurality of bidding management units can be provided to each node. In addition, the bidding management unit can be implemented as independent middleware or an internal function in the OS, or can be implemented inside one of the processing units. Generally, processing and communications at bidding are simplified, if the bidding management unit is implemented as follows: when there are a single supplier and a plurality of consumers, the bidding management unit is implemented inside the supplier, and in turn, when there are a plurality of suppliers and a single consumer, the bidding management unit is implemented inside the consumer. For this reason, in the first embodiment, each of the physical resource managers 42 and 52 (supplier) only supplies the CPU use rate to a plurality of application programs (consumers), so that the bidding management units 42b and 52b are provided inside the physical resource managers 42 and 52, respectively. Each of the sensor-information displaying application programs (consumer) only receives the CPU use rate and the sensor information from a plurality of application programs (suppliers and producers), so that the bidding management units 45b and 55b are provided inside the respective sensor-information displaying application programs. For example, in the node 2, the bidding management unit 42b is provided inside the physical resource manager 42, and the bidding management unit 45b is provided inside the radar-information displaying application 45.

Furthermore, in a case of an application program that is constantly activated since power-up such as the information displaying application program, the logic processing unit can be implemented as integrated in the application program. Details of functions of the wrappers 43c, 44c, 53c, and 54c will be described later.

3. Supply and Consumption of Resource

3.1 Resource

The resource is explained below. The first embodiment is an example based on a supply chain model that data created by an application program is treated as a resource in addition to the CPU use rate, which is a physical resource.

Why data is treated as a resource is owing to the following reason. Because each of the signal processing units for respective sensor signals is separated from each of the information displaying units for respective sensor information, if only the CPU use rate is treated as a resource while the sensor information is not treated as a resource, there is a possibility that the resources could be allocated by ignoring supply-consumption relation of the sensor information. For example, a situation is possible such that the sonar-information displaying application 55 could not be executed because the CPU use rate is not allocated, while the sonar-signal processing applications 44 and 54 are executed, to each of which the CPU use rate is allocated. In such case, the CPU is wasted to create sensor information not to be used. To separate each of the signal processing units from each of the information displaying units while avoiding such situation, data is also treated as a resource in addition to the CPU use rate.

The CPU use rate is a proportion (%) at which an application program uses a CPU per unit-time of processing, which will be described later. For example, where the unit-time of processing is one second, and the CPU use rate is at 30%, it means that the application program can use a CPU for 300 milliseconds. Although the CPU use rate (%) is used in the first embodiment, instead of this, for example, CPU use time (millisecond) can be used. In addition, data in the first embodiment includes radar information and sonar information.

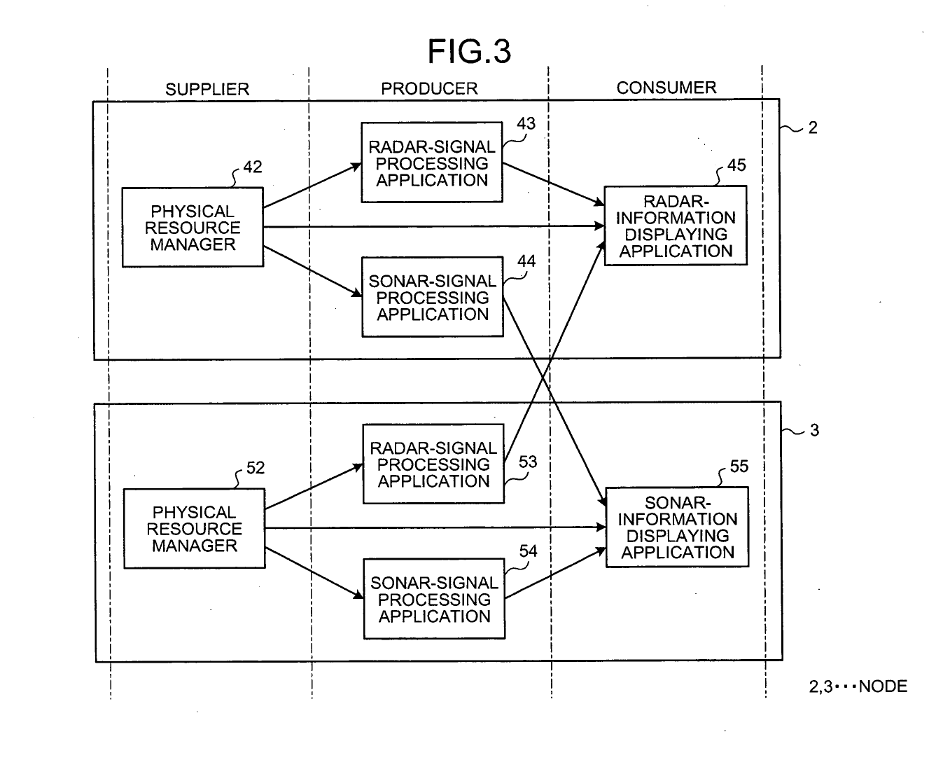

As shown in FIG. 3, in the supply chain model according to the first embodiment, the physical resource managers 42 and 52 correspond to suppliers, the radar-signal processing applications 43 and 53 and the sonar-signal processing applications 44 and 54 correspond to producers, and the radar-information displaying application 45 and the sonar-information displaying application 55 correspond to consumers.

The physical resource managers 42 and 52, which are suppliers only supplying a resource, are middleware that manages the physical resource, i.e., the CPU use rate. The physical resource managers 42 and 52 can be integrated in the OS as part of the OS.

The CPU use rate is supplied from the suppliers, i.e., the physical resource managers 42 and 52, to respective application programs. In the case shown in FIG. 3, the CPU use rate is supplied from the physical resource manager 42 to the radar-signal processing application 43, the sonar-signal processing application 44, and the radar-information displaying application 45, and supplied from the physical resource manager 52 to the radar-signal processing application 53, the sonar-signal processing application 54, and the sonar-information displaying application 55.

The producers, namely, the radar-signal processing applications 43 and 53, and the sonar-signal processing applications 44 and 54, create certain sensor information by consuming respective CPU use rates, and supply the created information to the radar-information displaying application 45 and the sonar-information displaying application 55. In other words, the sensor-signal processing applications from among the application programs are the producers that supply the sensor information.

The consumers, i.e., the radar-information displaying application 45 and the sonar-information displaying application 55, only consume the CPU use rate and the sensor information, and do not supply resource to other application programs. In other words, the information displaying applications from among the application programs are the consumers that only consume the CPU use rate and the sensor information, and do not supply resource to other application programs.

Each of the processing units as an application program works only when the processing unit can win the bids for all resources to consume for itself. Although each of the signal processing units is present in both of the nodes 2 and 3 to distribute loads, if the corresponding application program is executed in either the node 2 or the node 3, the sensor information is created. For example, if obtaining an allocation of the CPU use rate, and receiving a supply of the radar information from either the radar-signal processing application 43 or the radar-signal processing application 53, the radar-information displaying application 45 is executed.

3.2 Method of Supplying Resource

The supply of a resource is explained below. A supply of the sensor information as data from among the resource supplies is carried out as the signal-processing application program actually supplies the sensor information to the sensor-information displaying application program. For example, a supply of the radar information obtained as a result of the signal processing to the radar-information displaying application 45 by the radar-signal processing application 43 results in a supply of the sensor information.

On the other hand, the supply of the CPU use rate is a conceptual process, and there is no explicit delivery. When creating an application program, it is implemented by creating the application program to be executed by using a CPU only if the application program can win a successful bid for the CPU use rate. If a practical behavior of the application program is not trustworthy, for example, when the application program is created by a third person, the application program can be checked by a method, for example, such that the physical resource managers 42 and 52 monitor the states of the OSs whether the application program uses the CPU use rate only at the proportion actually obtained by the successful bid. In this case, if the application program uses the CPU use rate at a proportion higher than that obtained by the successful bid, it is possible to force the application program to comply the allocation of the CPU use rate, for example, by carrying out a forced termination of the application program with an interrupting processing. The resource allocation as described above is carried out through the bidding in the resource management apparatus.

3.3 Method of Determining Resource Allocation

(a) CPU Use Rate

A method of determining a consumption volume and a supply volume of the CPU use rate is described below. Each of the application programs calculates a CPU use rate at which the application program is to use a CPU per unit-time of processing, i.e., a consumption volume, and then specifies or determines the CPU use rate. The CPU use rate can be determined as a creator of an application program explicitly describes a numerical value or a calculation expression in a source code of the application program, or a compiler can determine the CPU use rate when compiling. Alternatively, each of the application programs performs actual measurement by monitoring the physical resource managers 42 and 52 and the states of the OSs when the application program is executed, and then estimates a use volume of the physical resource from the measurement history.

The physical resource managers 42 and 52 calculate a resource volume available to be supplied to the application programs. In the first embodiment, the supply volume to the application programs is a value obtained by subtracting a margin for operations of the OS, the middleware and the security from a percentage indicating a proportion of the total number of CPUs to the total utilization time. In the first embodiment, it is assumed that the supply volume from each of the nodes is 180%, which is obtained by subtracting the margin 20% from 200% equivalent to two CPUs.

(b) Sensor Information

A method of determining a consumption volume and a supply volume of the sensor information is described below. The sensor information is a resource other than the physical resource. A consumption volume and a supply volume of the sensor information are specified as a creator of an application program explicitly describes a numerical value or a calculation expression in a source code of the application program as part of the logic of the application program.

For example, the sonar-signal processing application 44 receives sensor signals in a predetermined sampling cycle from the sonar 7, which is a sensor, so that the consumption volume is the volume of the sensor signals (such as a bit rate). Moreover, the sonar-signal processing application 44 performs certain signal processing, and supplies sensor information to the sonar-information displaying application 55, so that the supply volume is the volume of the sensor information (such as a bit rate).

In addition, as described later, the consumption volume and the supply volume change based on bidding, and the CPU use rate in each node also changes in accordance with the sensor signal volume supplied to the node. For example, in the node 2, the CPU use rate changes in accordance with a sensor signal volume supplied to the node 2, and similarly in the node 3, the CPU use rate changes in accordance with a sensor signal volume supplied to the node 3. Accordingly, for example, the total volume of sensor signals output from the radar 5 is distributed into the node 2 and the node 3, so that each of the nodes requires a CPU use rate appropriate to the distributed volume.

(c) Notification of Resource Allocation

In each processing unit, the consumption volume or the supply volume determined or specified through the above procedure is notified to the resource bidding unit implemented inside the processing unit. The resource bidding unit makes a bid corresponding to the consumption volume or the supply volume to the bidding management unit.

4. Configuration of Resource Management Apparatus

4.1 Resource Management Apparatus

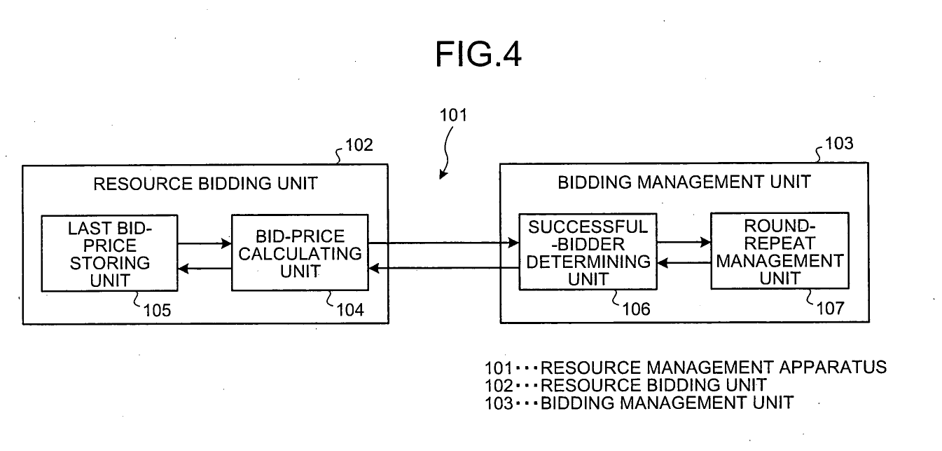

A resource management apparatus 101 according to the first embodiment includes a plurality of resource bidding units 102 and a plurality of bidding management units 103. FIG. 4 is a schematic diagram for presenting a flow of data between one of the resource bidding units 102 and one of the bidding management units 103 for explaining relation between the resource bidding unit 102 of each of the application programs and the corresponding bidding management unit 103.

For example, in the case of the node 2, in the matter of the CPU use rate, each of the resource bidding units 42a, 43a, 44a, and 45a corresponds to the resource bidding unit 102, while the bidding management unit 42b corresponds to the bidding management unit 103. In the matter of data of the radar information, each of the resource bidding units 43a (and 53a), and 45a of the radar-signal processing application 43 corresponds to the resource bidding unit 102, while the bidding management unit 45b corresponds to the bidding management unit 103.

The resource bidding unit 102 includes a bid-price calculating unit 104 and a last bid-price storing unit 105. The bidding management unit 103 includes a successful-bidder determining unit 106 and a round-repeat management unit 107.

Detailed operations of each of structural elements of the resource management apparatus 101 are described below.

4.2 Resource Bidding Unit

First of all, processing performed by the resource bidding unit 102 is described below. The resource bidding unit 102 makes a bid to the bidding management unit 103 for the consumption volume or the supply volume of the resource obtained by the determination described above. In other words, the resource bidding unit 102 provides information about its own resource. Bidding is performed as the resource bidding unit 102 makes bids to the bidding management unit 103 a plurality of times, i.e., over a plurality of rounds.

In each of the rounds, the bid-price calculating unit 104 calculates a bid price. In the calculation of a bid price, the value needs to be priced to maximize profits among processing units by selling and buying the resource at the price.

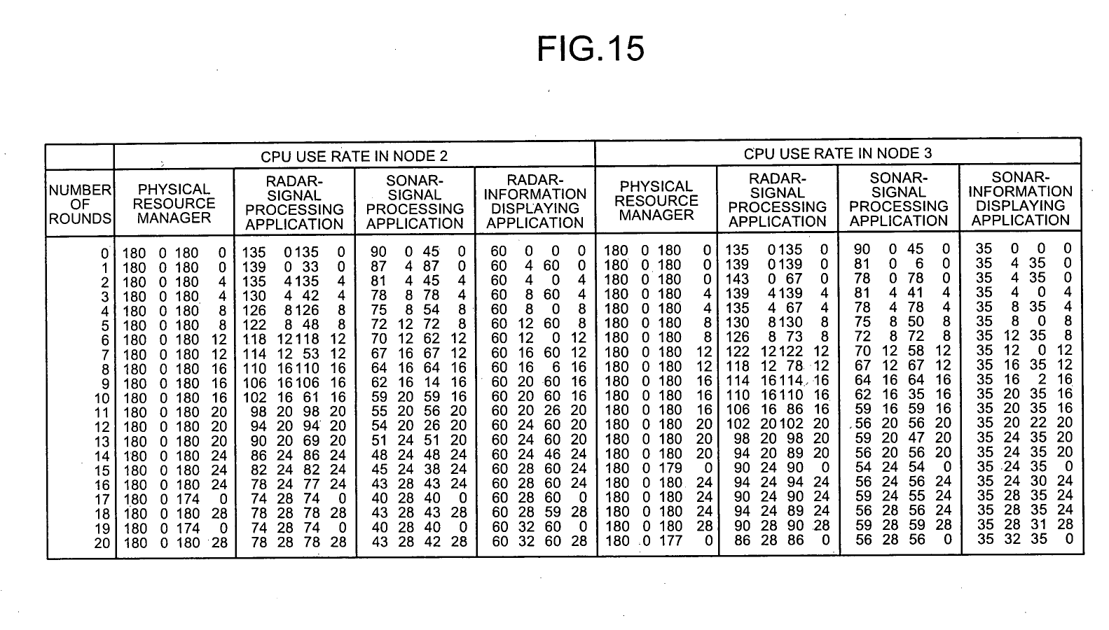

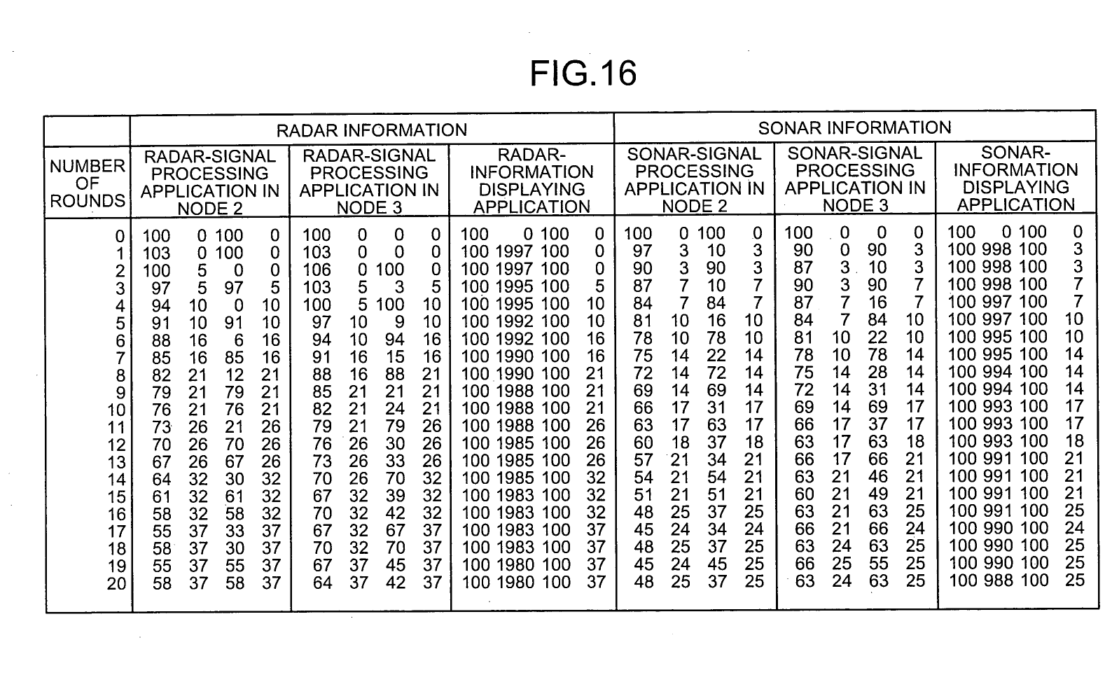

Specific operations of the bid-price calculating unit 104 vary depending on which of the supplier, the producer, and the consumer the processing unit is. Each of the cases is explained below. In FIG. 15, a bid volume, a bid price, a contract volume and a contract price of the CPU use rate in each of the processing units in the nodes 2 and 3 are shown. In FIG. 16, a bid volume, a bid price, a contract volume and a contract price of data in each of the processing units are shown. Figures arranged in each unit in FIGS. 15 and 16 indicate bid volumes, bid prices, contract volumes and contract prices, respectively from the left. The cases are explained below with reference to FIGS. 15 and 16.

(a) Case of Supplier

Because the supplier does not need to hold back a resource that the supplier can provide, the supplier can make a bid at whatever low price to maximize the volume of the resources to be sold. Therefore, the bid-price calculating unit 104 of the supplier can make a bid at a fixed value anytime. In the first embodiment, it is assumed that the physical resource managers 42 and 52 as the suppliers are anytime to make a bid for the CPU use rate at the price zero. For this reason, the last bid-price storing unit 105 can be omitted in the case of the supplier.

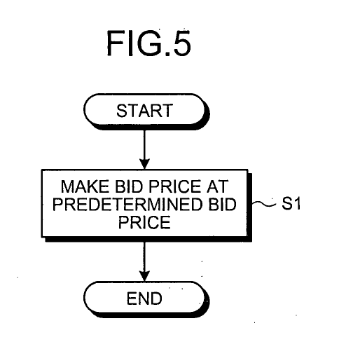

An example of a flow of processing performed by the bid-price calculating unit 104 of the supplier is explained below with reference to FIG. 5. The bid-price calculating unit 104 takes a bid price at a predetermined bid price, for example in this case, a fixed value zero (step S1).

(b) Case of Producer

The producer can buy a resource at a high price to create its own resource if the resource can be sold at a high price, however, if the producer cannot avoid the selling price going below the buying price, the producer needs to stop trading. To stop trading, the bid-price calculating unit 104 of the producer performs the following processing.

In the first round, the bid-price calculating unit 104 uses a value recorded in the last bid-price storing unit 105 as a bid price. In the last bid-price storing unit 105, zero is recorded as the initial value. From the second round, the bid-price calculating unit 104 adjusts the bid price in accordance with whether the last bid is successfully accepted in the previous round.

The bid-price calculating unit 104 makes a bid for its own resource to provide by taking a predicted value of the amount of bid prices (buying price) of resources to consume for itself as a bid price (selling price) (for example, if the producer is the radar-signal processing application 43, its own resource to provide is data, the radar information, and the resource to consume is the CPU use rate). The predicted value of a bid price (buying price) of the resource for the producer to consume is calculated by a method, for example, obtaining the amount of contract prices in the previous round of resources for the producer to consume (the contract price is not necessarily a value at which the processing unit has managed to make the successful bid; and if the processing unit has failed to make successful bid, the contract price can be a value of a successful bid made by another processing unit). The bid-price calculating unit 104 calculates a bid price of the resource for the producer to consume is calculated by a method according to which, for example, if the resource is not sufficiently won in bidding in the previous round, the bid price of the resource is increased by a predetermined amount.

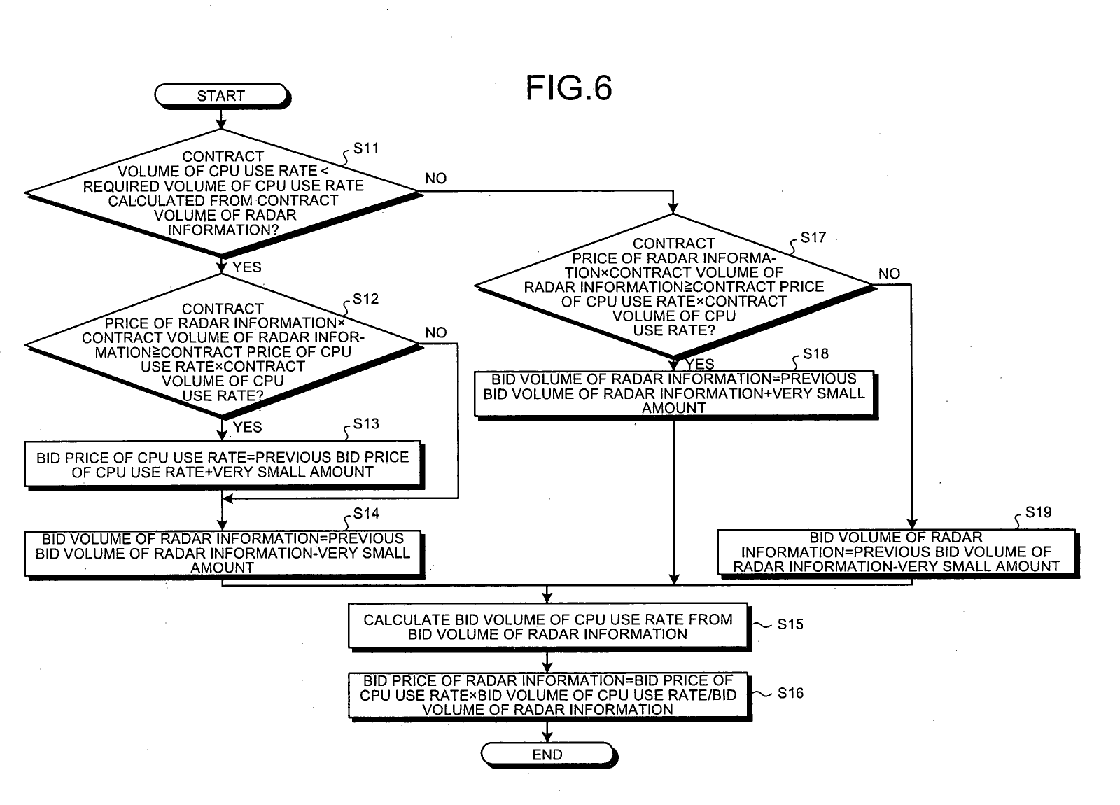

Processing shown in FIG. 6 is to be executed by the radar-signal processing application 43 directly before the start of each round in the bidding processing, and determines a bid price in each round. The determined bid price is supplied to the bidding management unit 103.

To begin with, the bid-price calculating unit 104 determines whether the contract volume of the CPU use rate is less than a required volume of the CPU use rate calculated from the contract volume of the radar information in the previous round (step S11). If, in the previous round, the contract volume of the CPU use rate is less than the required volume (Yes at step S11), the bid-price calculating unit 104 determines whether a product of the contract price of the radar information and the contract volume of the radar information is equal to or larger than a product of the contract price of the CPU use rate and the contract volume of the CPU use rate in the previous round (step S12).

FIGS. 15 and 16 are an example when the radar-signal processing application 43 requires 135% of the CPU use rate to create “100” of the radar information.

For example, in a case of the radar-signal processing application 43 in the node 2, the process control goes to Yes at step S11 in the round 5, where the contract volume of the CPU use rate is “48” in FIG. 15, and the contract volume of the radar information in FIG. 16 is “91”. In this case, the required volume of the CPU use rate calculated from the contract volume of the radar information, “91”, is “123”, which is more than the contract volume of the CPU use rate, “48”.

If, in the previous round, the product of the contract price of the radar information and the contract volume of the radar information is equal to or larger than the product of the contract price of the CPU use rate and the contract volume of the CPU use rate (Yes at step S12), the process control goes to step S13. The case of Yes at step S12 means what is called over the break-even point (i.e., the selling price exceeds the buying price).

Such case is observed, for example, in the round 19 of the radar-signal processing application 43 in the node 2: where the contract volume is “74”, the contract price is “0”, and the product is “0” in FIG. 15 in the matter of the CPU use rate; and the contract volume is “55”, the contract price is “37”, and the product is “2,035” in FIG. 16 in the matter of the radar information.

If Yes at step S12, the radar-signal processing application 43 is allowed to increase the CPU use rate, consequently, the bid-price calculating unit 104 adds a very small amount (d1), which is a predetermined amount, to the previous bid price of the CPU use rate (step S13). The very small amount to be added is “4” in this case. In FIG. 15, for example, from the round 5 to the round 6 of the radar-signal processing application 43 in the node 2, the bid price is increased from “8” to “12”.

If, in the previous round, the product of the contract price of the radar information and the contract volume of the radar information is not equal to or larger than the product of the contract price of the CPU use rate and the contract volume of the CPU use rate (No at step S12), the bid-price calculating unit 104 subtracts a very small amount (d2), which is a predetermined amount, from the previous bid volume of the radar information to decrease the bid volume of the radar information for the radar-signal processing application 43 (step S14). The case of No at step S12 means what is called below the break-even point.

For example, in the round 18 of the radar-signal processing application 43 in the node 2, the contract volume is “78”, the contract price is “28”, and the product of those is “2,184” in the matter of the CPU use rate, as shown in FIG. 15. Correspondingly, in the matter of the radar information, the contract volume is “30”, the contract price is “37”, and the product is “1,110”, as shown in FIG. 16. In such case, the radar-signal processing application 43 decreases the bid volume of the radar information from “58” to “55” from the round 18 to the round 19.

The bid-price calculating unit 104 then calculates a changed bid volume of the CPU use rate from the decreased bid volume of the radar information (step S15). The CPU use rate obtained from the calculation at step S15 is supposed to satisfy a CPU use rate required to create the radar information.

The bid-price calculating unit 104 calculates a bid price of the radar information by dividing the product of the bid price and the bid volume of the CPU use rate by the bid volume of the radar information (step S16).

At step S11, if, in the previous round, the contract volume of the CPU use rate is not less than the required volume of the CPU use rate (No at step S11), in other words, if the CPU use rate required to process the radar information is ensured, the bid-price calculating unit 104 determines whether a product of the contract price of the radar information and the contract volume of the radar information is equal to or larger than a product of the contract price of the CPU use rate and the contract volume of the CPU use rate in the previous round (step S17).

For example, the process control goes to No at step S11 in the round 18 of the radar-signal processing application 43 in the node 2, as shown in FIG. 15, where the contract volume of the CPU use rate is “78”, and the contract volume of the radar information is “30”, as shown in FIG. 16. In this case, the CPU use rate required for the contract volume of the radar information, “30”, is “41”, which is less than the contract volume of the CPU use rate, “78”.

If, in the previous round, the product of the contract price of the radar information and the contract volume of the radar information is equal to or larger than the product of the contract price of the CPU use rate and the contract volume of the CPU use rate (Yes at step S17), in other words, in a case of what is called over the break-even point; the bid-price calculating unit 104 adds a very small amount (d3), which is a predetermined amount, to the previous bid volume of the radar information to increase the bid volume of the radar information for the radar-signal processing application 43 (step S18).

If the product of the contract price of the radar information and the contract volume of the radar information is not equal to or larger than the product of the contract price of the CPU use rate and the contract volume of the CPU use rate in the previous round (No at step S17), in other words, in a case of what is called below the break-even point; the bid-price calculating unit 104 subtracts a very small amount (d4), which is a predetermined amount, from the previous bid volume of the radar information to decrease the bid volume of the radar information for the radar-signal processing application 43 (step S19). The bid-price calculating unit 104 then executes the processing at steps S15 and S16.

(c) Case of Consumer

The consumer performs processing by buying the resource to consume for itself at a price within an upper limit of the buying price appropriate to a priority of the application program in the phase, i.e., a situation. The priority of each of the application programs can be changed depending on a situation. The upper limit can be described by a creator of the application program in the source code of the application program, can be calculated by the application program by recognizing the phase, or can be specified directly or indirectly by a user from a terminal.

In the first embodiment, it is assumed that: the radar information has a higher priority than the sonar information; where the upper limit of the amount of a purchase of the resource for the radar-information displaying application 45 is “200,000”, and the upper limit of the amount of a purchase of the resource for the sonar-information displaying application 55 is “100,000”; and if the resource cannot be purchased within the limit, the purchase of the resource is waived in the unit-time of processing. Thus, the bidding is performed, in which the priority of the sensor signals are reflected.

The bid-price calculating unit 104 uses a value recorded in the last bid-price storing unit 105 as a bid price. In the last bid-price storing unit 105, zero is recorded as the initial value. From the second round, the bid-price calculating unit 104 adjusts the bid price in accordance with whether the last bid is successfully accepted in the previous round.

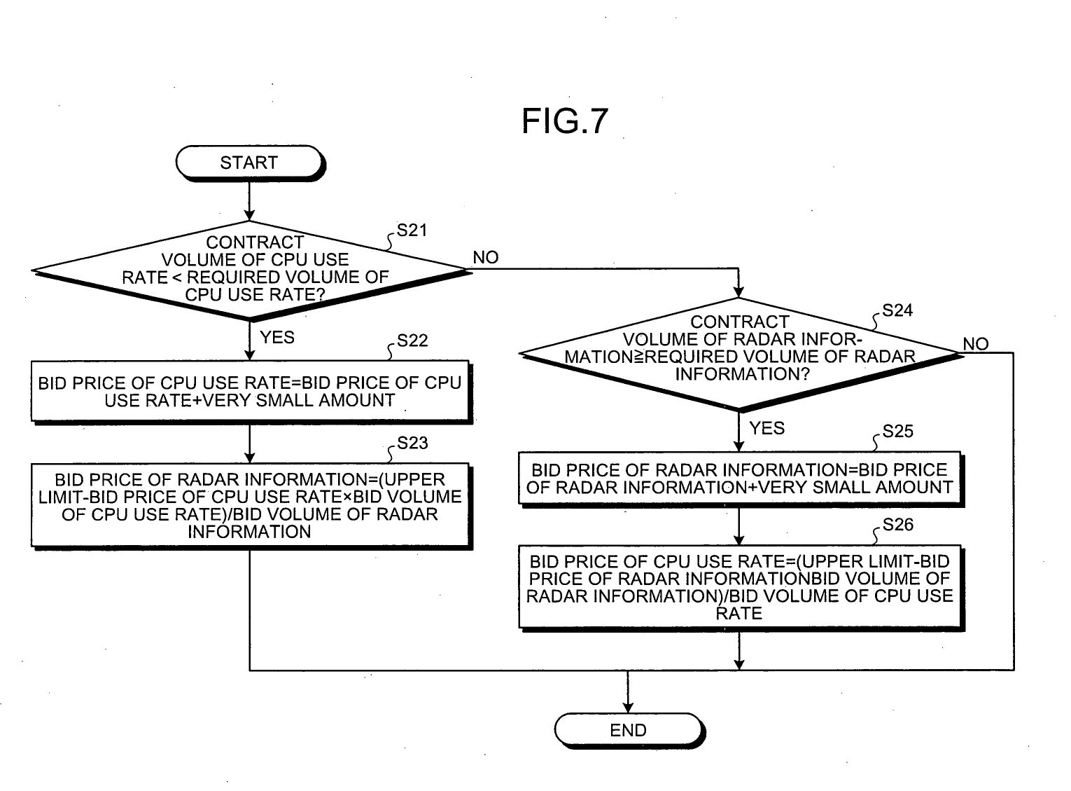

An example of a flow of processing performed by the bid-price calculating unit 104 of the consumer is explained below with reference to FIG. 7. The bid-price calculating unit 104 determines whether the contract volume of the CPU use rate is less than a required volume of the CPU use rate (step S21).

Here, the required volume is a fixed value. For example, in FIG. 15, the required volume of the CPU use rate for the radar-information displaying application 45 in the node 2 is “60”, and the contract volume is “60” in a result in FIG. 15.

If the contract volume of the CPU use rate is less than the required volume of the CPU use rate (Yes at step S21), the bid-price calculating unit 104 increases the bid price of the CPU use rate by a very small amount (d5), which is a predetermined amount (step S22).

The bid-price calculating unit 104 then calculates a bid price of the radar information by subtracting a product of the bid price of the CPU use rate and the bid volume of the CPU use rate from the upper limit, and dividing the subtracted value by the bid volume of the radar information (step S23). In other words, the bid price of the radar information is determined within a range such that the sum of the product of the bid price of the CPU use rate and the bid volume of the CPU use rate, and the product of the bid price of the radar information and the bid volume of the radar information does not exceed the upper limit.

If the contract volume of the CPU use rate is equal to or more than the required volume of the CPU use rate (No at step S21), the bid-price calculating unit 104 determines whether a contract volume of the radar information is equal to or more than a required volume of the radar information (step S24).

The required volume of the radar information is a fixed value in this case. For example, the required volume of the radar information for the radar-information displaying application 45 in the node 2 is “100”, and the contract volume is “100” in a result in FIG. 16.

If the contract volume of the radar information is equal to or more than the required volume of radar information (Yes at step S24), the bid-price calculating unit 104 increases the bid price of the radar information by adding a very small amount (d6), which is a predetermined amount (step S25). The reason for this is to price the CPU use rate at a lower bid price by pricing the radar information at a higher value.

Precisely, the bid-price calculating unit 104 calculates a bid price of the CPU use rate by subtracting a product of the bid price of the radar information and the bid volume of the radar information from the upper limit, and dividing the subtracted value by the bid volume of the CPU use rate (step S26). In other words, the bid price of the CPU use rate is determined within a range such that the sum of the product of the bid price of the CPU use rate and the bid volume of the CPU use rate, and the product of the bid price of the radar information and the bid volume of the radar information does not exceed the upper limit.

If the contract volume of the radar information is not equal to or more than the required volume of radar information (No at step S24), the bid-price calculating unit 104 terminates the processing.

4.3 Bidding Management Unit

Processing performed by the bidding management unit 103 is described below. The bidding management unit 103 determines which processing unit wins the bid for the resource based on bids from the resource bidding units 102, i.e., bid information, and notifies the resource bidding units 102 of a result of the bidding. The bidding result information includes information whether the processing unit has made a successful bid, and information about a contract price (which is not necessarily a price at which the processing unit has managed to make the successful bid; and if the processing unit has failed to make successful bid, the contract price can be a price of a successful bid made by another processing unit).

The resource bidding unit 102 of each of the processing units receives the bidding result information, and performs processing for a unit-time based on the received result. The processing unit(s) that has managed to win the bid(s) in the end for the resource(s) to consume performs an operation of consuming the resource. Usually, the processing unit(s) that has failed to win bids for all of the resources to consume in a unit-time of processing does not perform processing within the unit-time of processing, and turns to a so-called sleep. However, if the processing unit still can perform some operation despite that the processing unit failed to win a bid for part of the resource to consume, the processing unit performs processing as much as the resource is available. By contrast, the processing unit(s) that has failed to win the bid for the resource to supply does not supply the resource in the following unit-time of processing.

In a case of the CPU use rate as a physical resource, when each of the application programs wins the CPU use rate in bidding, the application program performs certain processing using the CPUs for a time obtained as a result of a successful bid by the application program, in the next unit-time of processing. In a case of data as a resource other than the physical resources, when each of the application programs wins data in bidding, the application program receives a supply of the data in accordance with a contract volume.

For example, the radar-signal processing application 43 is executed for a portion of the CPU time obtained as a result of the successful bid. As described above, the radar-information displaying application 45 is executed for a portion of the CPU time obtained as a result of a successful bid by using data obtained as a result of a successful bid when the both bids for the CPU use rate and the data (from either the radar-signal processing application 43 or 53) are successfully accepted.

(a) Round Management

The round management is explained below. In the first embodiment, the number of rounds, i.e., the number of times of repeat is a condition for the termination of bidding. In other words, the resource management apparatus 101 is managed not to perform the bidding processing beyond a predetermined number of rounds. Precisely, the round-repeat management unit 107 of the bidding management unit 103 the bidding processing by counting the number of rounds per unit-time of processing, and monitoring to perform successful bidder determination up to a predetermined number of times.

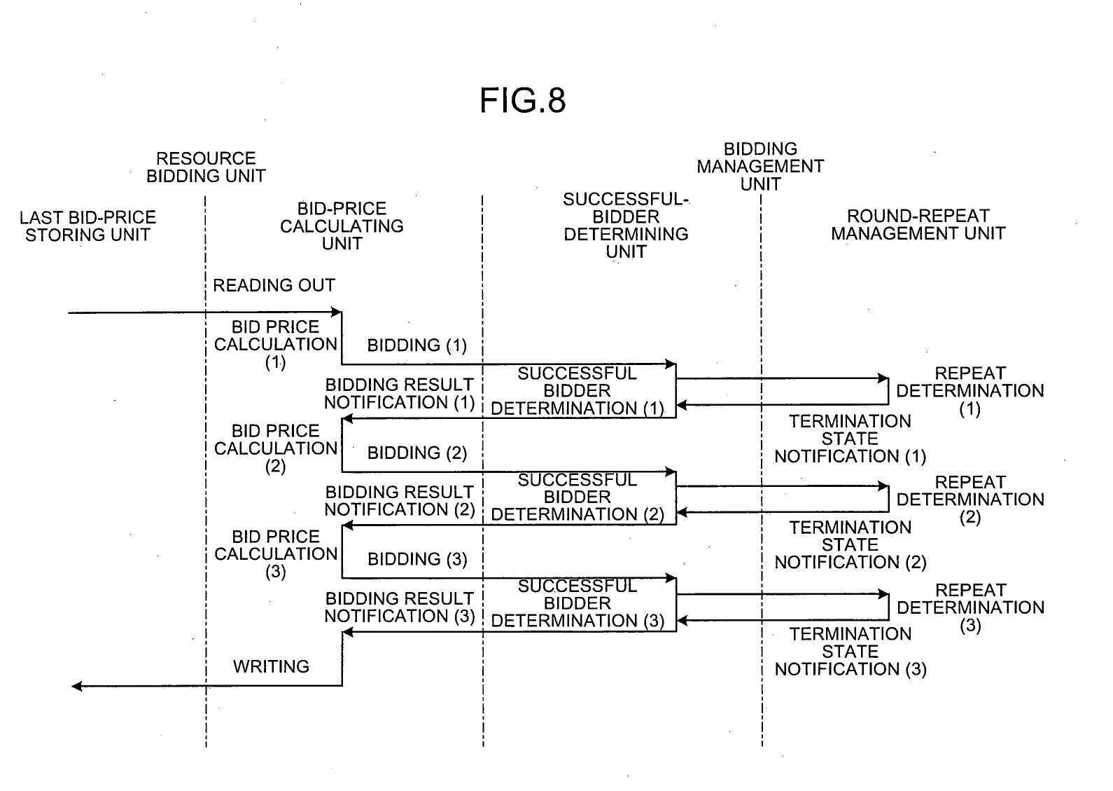

As shown in FIG. 8, the resource bidding unit 102 reads a last bid price in the previous round from the last bid-price storing unit 105 at first, then calculates a bid price by using the last bid price, and makes a bid (bid (1)). In response to the bid, the bidding management unit 103 performs successful bid processing, and determines a successful bidder (successful bidder determination (1)). In response to the successful bidder determination (1), the resource bidding unit 102 calculates the next (i.e., the second) bid price, and makes a bid again (bid (2)). Also in response to the bid (2), the bidding management unit 103 performs the successful bid processing, and determines a successful bidder (successful bidder determination (2)). Furthermore, in response to the successful bidder determination (2), a bid is made again (bid (3)), and the successful bid processing is performed. In the first and second bidding, the round-repeat management unit 107 does not output a termination notice, which will be described later, to the successful-bidder determining unit 106.

In this way, as processing of a successful bid to one time of bidding forms one round, the round-repeat management unit 107 counts the number of rounds by incrementing the number of rounds when a bid is input, or a bidding result is output.

If the number of rounds reaches the predetermined number, the round-repeat management unit 107 detects that the number of rounds is the predetermined number. The detection result is notified to the successful-bidder determining unit 106 as a termination notice. The successful-bidder determining unit 106 notifies the resource bidding unit 102 of information about the termination notice. When receiving the termination notice, the bid-price calculating unit 104 does not calculates a bid price again, and then writes the final bid price of the bidding result information into the last bid-price storing unit 105.

As described above, the resource management apparatus 101 is managed not to make bids more than a predetermined number of times by using the number of rounds as the termination condition of the bidding processing, so that the resource management apparatus 101 is configured to ensure that the bidding processing is to be terminated within a predetermined time.

(b) Unit-Time of Processing

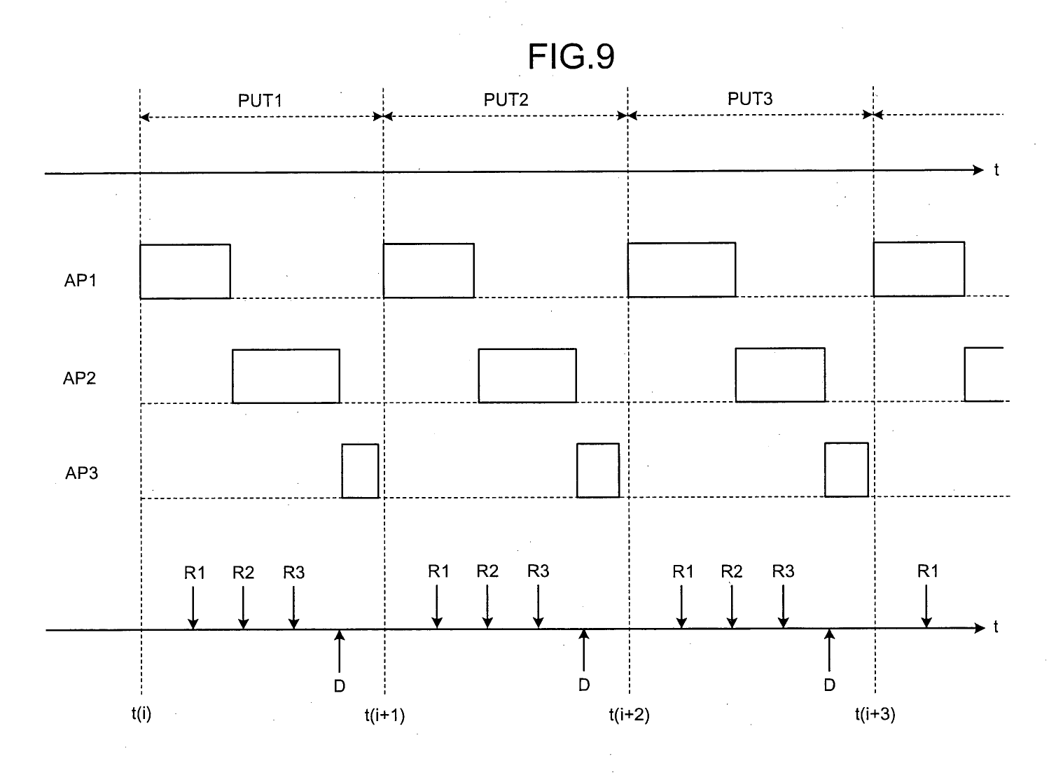

The unit-time of processing is explained below. In the embodiments, the unit-time of processing is a time for executing each of the application programs. FIG. 9 depicts a case when the three application programs in the node 2 (the radar-signal processing application 43, the sonar-signal processing application 44, and the radar-information displaying application 45) are executed. FIG. 9 presents that the three application programs, namely, AP1, AP2, and AP3, are executed for respective time periods in accordance with the respective CPU use rates, which is a resource allocated to each unit-time of processing.

With respect to each of the unit-time of processing, distribution of the resources to each of the application programs in the next unit-time of processing is determined by bidding. In a unit-time of processing (PUT1) between a time t(i) and a time t(i+1), the predetermined number of times of biddings are performed as described above, and a successful bidder is determined in the end. In the first embodiment, the predetermined number of times is three times. In accordance with the determined bidding result, each of the application programs is executed for an allocated portion of the CPU use rate. In FIG. 9, a CPU use rate for each of the application programs in a unit-time of processing (PUT2) between the time t(i+1) and a time t(i+2) is determined in the bidding processing during the unit-time of processing (PUT1).

In FIG. 9, after a first bidding (R1) is performed, a second bidding (R2) is performed, and then a third bidding (R3) is performed. After the third bidding, details of a successful bid are finally determined at timing D. In accordance with the bidding result, each of the application programs is executed as much as the allocated CPU use rate in the next unit-time of processing.

Likewise, the CPU use rate for each of the application programs in the unit-time of processing (PUT3) is determined in the bidding processing in the unit-time of processing (PUT2). Similarly in the following processes, the CPU use rate to be allocated to each of the application programs in the next unit-time of processing is determined by bidding in the previous unit-time of processing.

(c) Successful-Bidder Determining Unit

In the bidding management unit 103 after receiving bid information, the successful-bidder determining unit 106 determines which application program is to win the resource in bidding.

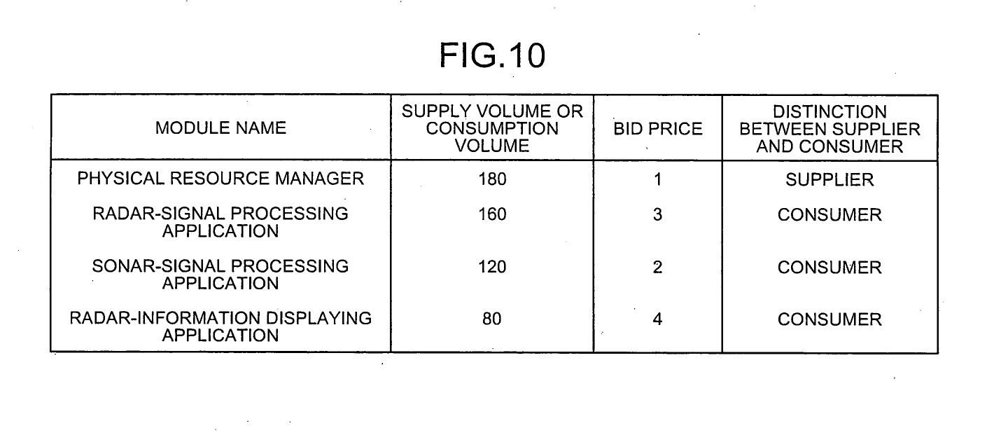

Operation of the successful-bidder determining unit 106 is explained below in an example where the bidding management unit 42b of the physical resource manager 42 makes a bid for the contents shown in FIG. 10.

The bid information includes information about module name, supply volume or consumption volume, bid price, and distinction between supplier and consumer. The module name indicates each of the processing units, and can be expressed in a numerical value, such as a process number, as well as a character string as shown in FIG. 10. The supply volume or the consumption volume, to what extent the resource is to be consumed or supplied, is specified by amount of unit defined with respect to each of the resources. In FIG. 10, the CPU use rate is specified in a percentage. The bid price is to specify at what price the resource is to be consumed or supplied by using a virtual currency. The specification can be indicated as a price per unit of a resource, or can be indicated as a total amount (product of price and volume). In FIG. 10, prices per unit of use rate are shown.

Operation of the successful-bidder determining unit 106 is explained below. First of all, operation of the successful-bidder determining unit 106 is explained below, in a case where there are a single supplier and a plurality of consumers, in other words, in a case of the bidding management unit 42b in the physical resource manager 42 in the first embodiment. In this case, in response to a bid from the consumers, the successful-bidder determining unit 106 determines a successful bidder by allocating the resources until no supply volume is left, or bid prices of bids from the consumers all become below the bid price of the bid from the supplier.

When the successful bidder is determined, the contract price is either the highest value in the bid prices of the bids from the consumers who have not obtained the resource to satisfy its own bid volume, or the bid price of the bid from the supplier, any of which is higher than the other.

For example, if bids are made as shown in FIG. 10, the supply volume 180% of the CPU use rate is allocated to the application programs as consumption volumes in total from the physical resource manager 42. In this case, in descending order of the bid price, 80% of the CPU use rate is allocated to the radar-information displaying application 45 at first. The remaining supply volume 100% of the CPU use rate is then allocated to the radar-signal processing application 43, of which the bid volume is 160%. The bid price three of the radar-signal processing application 43, which is not allocated with a sufficient resource to satisfy its bid volume 160%, is higher than the bid price of the physical resource manager 42 zero, so that the contract price is three.

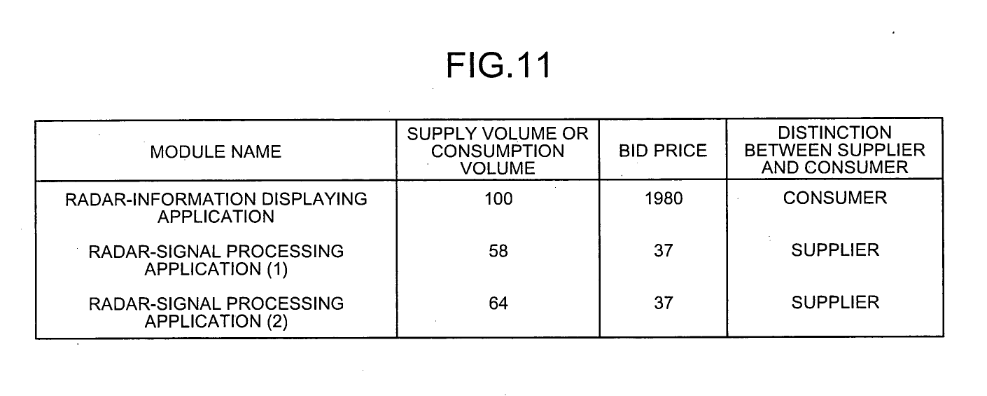

An operation of the successful-bidder determining unit 106 is explained below in a case where the bidding management unit 45b of the radar-information displaying application 45 performs bidding in response to bids shown in FIG. 11.

In FIG. 11, the consumption volume 100 of the radar-information displaying application 45 means that the radar-information displaying application 45 needs 100% of data to perform displaying processing. The supply volume “58” of the radar-signal processing application 43 in the node 2 means that the radar-signal processing application 43 can process and supply 58% of the radar information at maximum. The maximum value “58” is a value determined from the CPU use rate available to the radar-signal processing application 43 in the node 2, and a setting value that the radar-signal processing application 43 can process 58% out of 100% of the radar information. Likewise, the supply volume “64” of the radar-signal processing application 53 in the node 3 means that the radar-signal processing application 53 can process and supply 64% of the radar information at maximum. The maximum value “64” is a value determined from the CPU use rate available to the radar-signal processing application 53 in the node 3, and a setting value that the radar-signal processing application 53 can process 64% out of 100% of the radar information.

The bid price “1,980” of the radar-information displaying application 45 means that the radar-information displaying application 45 can make a bid at “1,980” as the maximum bid price. Both of the bid prices of the radar-signal processing application 43 in the node 2 and the radar-signal processing application 53 in the node 3 are “37”, and it means that the respective minimum values of bid prices from the application programs are both “37”.

In this case, because the bid price is a unit price per unit use rate of the CPU use rate, the CPU use rate does not need to be considered when comparing the magnitude of the bid price. However, if bidding is performed by taking an amount as a bid price, the successful-bidder determining unit 106 needs to determine a successful bidder by calculating the unit price by dividing a bid amount by the CPU use rate, and comparing divided unit prices.

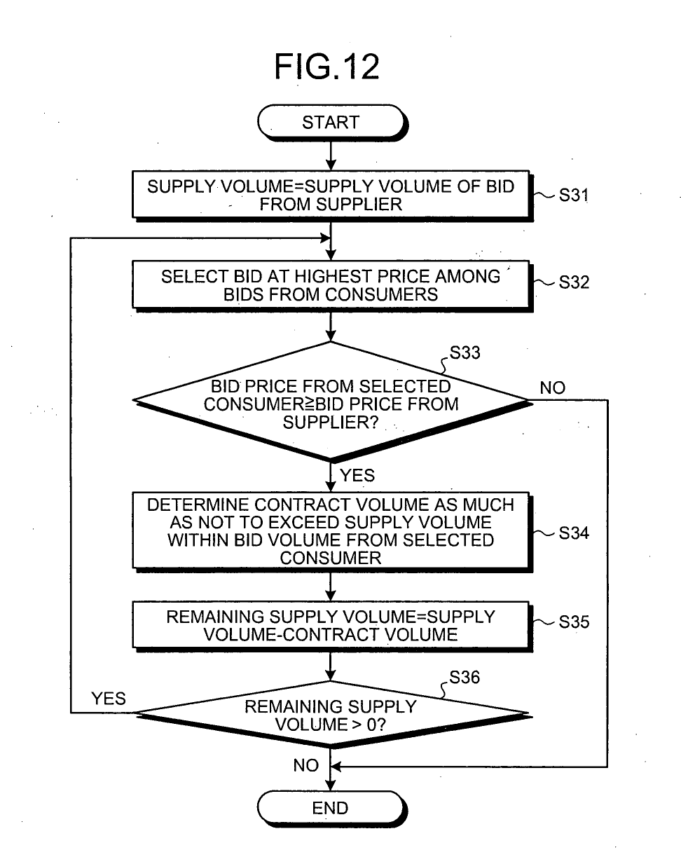

An example of a flow of processing performed by the successful-bidder determining unit 106 of the physical resource manager 42, which is a supplier, is explained below with reference to FIG. 12 in a case of the node 2.

To begin with, the successful-bidder determining unit 106 takes a supply volume determined by the supplier, i.e., a supply volume in supplier's bid information, as the supply volume (step S31).

The successful-bidder determining unit 106 selects a bid at the highest price from among bid information from consumers of the resource (step S32). In the example as shown in FIG. 10, the bid from the radar-information displaying application 45 is selected.

The successful-bidder determining unit 106 determines whether the bid price from the selected consumer is equal to or higher than a bid price from the supplier (step S33). In the case shown in FIG. 10, the bid price from the physical resource manager 42 as the supplier is one, and the bid price from the radar-information displaying application 45 as the consumer is four (Yes at step S33), so that the process control goes to step S34.

By contrast, if the bid price from the selected consumer is less than the bid price from the supplier (No at step S33), the successful-bidder determining unit 106 terminates the processing.

At step S34, the successful-bidder determining unit 106 determines a contract volume as much as not to exceed the supply volume within the volume of the bid from the selected consumer. In the case of FIG. 10, the consumption volume “80” of the radar-information displaying application 45 can be subtracted from the supply volume 180, so that the consumption volume “80”, which does not exceed the supply volume, is determined as the contract volume.

The successful-bidder determining unit 106 then calculates a remaining supply volume, in other words, calculates the remaining supply volume by subtracting the contract volume from the supply volume (step S35). In the case shown in FIG. 10, the remaining supply volume “100” is calculated by subtracting the contract volume “80” from the supply volume “180”.

The successful-bidder determining unit 106 then determines whether the remaining supply volume is equal to zero or less (step S36).

If the remaining supply volume is more than zero (Yes at step S36), the process control goes back to step S32. By contrast, if the remaining supply volume is equal to zero or less (No at step S36), the processing is terminated.

If the process control goes back to step S32, the processing at steps S32 to S36 is repeatedly performed on bids from the consumers other than the successful bidder.

The process from step S31 to step S36 is repeated over a predetermined number of times (in this case, three times). The process from step S31 to step S36 corresponds to one round.

Thus, if there is a plurality of resource consuming programs that consumes the resources among the application programs, the bidding management unit 103 performs resource allocation to allocate a resource preferentially to an application program that makes a bid at a higher value among the resource consuming programs.

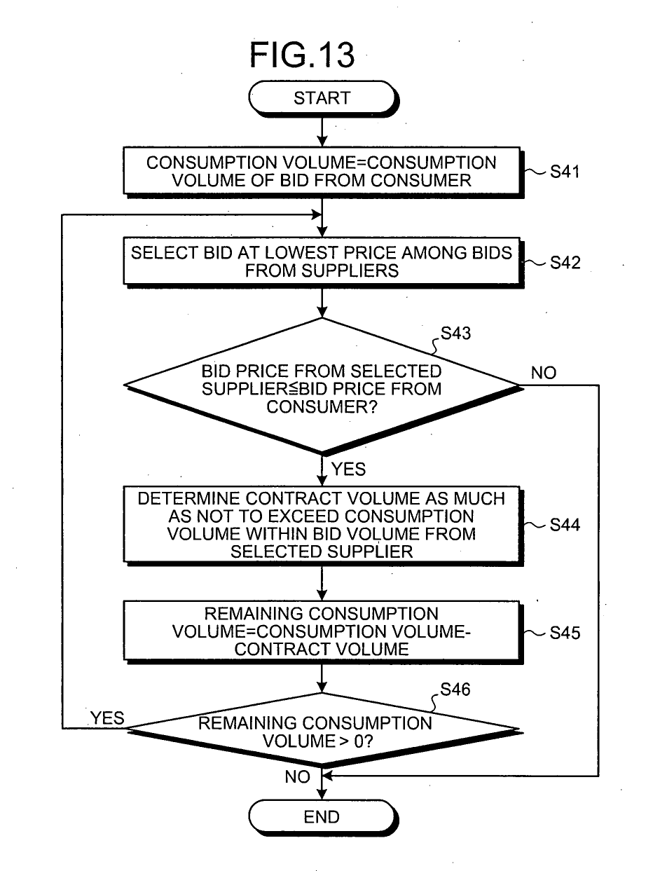

On the other hand, if there are a plurality of suppliers and a single consumer, such as the sensor information, precisely, in the case of the bidding management unit 45b of the radar-information displaying application 45 in the first embodiment, the operation of the successful-bidder determining unit 106 shown in FIG. 12 can be changed to read “supply” as to “consumption”, and “higher” as to “lower”. An example of a flow of processing performed by the successful-bidder determining unit 106 of the information displaying application is explained below with reference to FIG. 13.

To begin with, the successful-bidder determining unit 106 takes a consumption volume determined by the consumer, i.e., a consumption volume in consumer's bid information, as the consumption volume (step S41).

The successful-bidder determining unit 106 selects a bid at the lowest price from among bid information from the suppliers of the resources (step S42). In the example as shown in FIG. 11, the radar-signal processing application 43 in the node 2 and the radar-signal processing application 53 in the node 3 make bids at the same value, i.e., at “37”. Therefore, for example, if priorities are predetermined to the two application programs in this case, one of the two application programs is to be selected. For example, the radar-signal processing application 43 is selected.

The successful-bidder determining unit 106 determines whether the bid price from the selected supplier is equal to or lower than a bid price from the consumer (step S43). In the case shown in FIG. 11, the bid price from the radar-information displaying application 45 as the consumer is “1,980” (Yes at step S43), so that the process control goes to step S44.

By contrast, if the bid price from the supplier exceeds the bid price from the consumer (No at step S43), the successful-bidder determining unit 106 terminates the processing.

At step S44, the successful-bidder determining unit 106 determines a contract volume as much as not to exceed the consumption volume within the volume of the bid from the selected supplier. In the case of FIG. 11, the supply volume “58” can be subtracted from the consumption volume “100” of the radar-information displaying application 45, so that the supply volume “58”, which does not exceed the consumption volume, is determined as the contract volume.

The successful-bidder determining unit 106 then calculates a remaining consumption volume, in other words, calculates the remaining consumption volume by subtracting the contract volume from the consumption volume (step S45). In the case shown in FIG. 11, the remaining consumption volume “42” is calculated by subtracting the contract volume “58” from the consumption volume “100”.

The successful-bidder determining unit 106 then determines whether the remaining consumption volume is equal to zero or less (step S46).

If the remaining consumption volume is more than zero (Yes at step S46), the process control goes back to step S42. By contrast, if the remaining consumption volume is equal to zero or less (No at step S46), the processing is terminated.

If the process control goes back to step S42, the processing at steps S42 to S46 is repeatedly performed on bids from the suppliers other than the successful bidder.

The process from step S41 to step S46 is repeated over a predetermined number of times (in this case, three times). The process from step S41 to step S46 corresponds to one round. The number of times of repeating a round is also predetermined, and it is three in the first embodiment.

Thus, if there is a plurality of resource supplying programs that supplies the resources among the application programs, the bidding management unit 103 performs resource allocation to allocate the resource preferentially to an application program that makes a bid at a lower value among the resource supplying programs.

(d) Round-Repeat Management Unit

The number of times of executing the processing explained in FIGS. 12 and 13 is counted by the round-repeat management unit 107. The round-repeat management unit 107 controls execution of the processing in FIGS. 12 and 13 to prevent the successful-bidder determining unit 106 from executing the processing beyond the predetermined number of times.

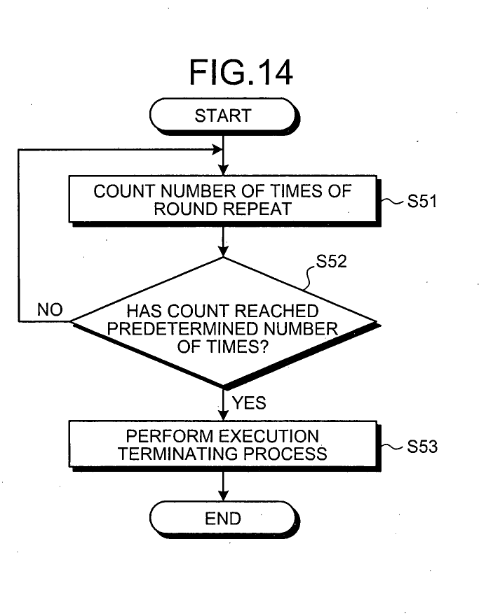

An example of a flow of processing performed by the round-repeat management unit 107 is explained below with reference to FIG. 14. The round-repeat management unit 107 counts the number of times of the round repeat (step S51). The round-repeat management unit 107 then determines whether the counted number of times of the round repeat reaches a predetermined number of times, which is three times in the first embodiment (step S52). If the counted number of times has not reached the predetermined number of times (No at step S52), the process control goes back to step S51. If the counted number of times has reached the predetermined number of times (Yes at step S52), the round-repeat management unit 107 performs an execution terminating process to terminate the processing in FIGS. 11 and 12 (step S53). In the execution terminating process, the termination notice is output to the resource bidding unit 102, together with or separately from the bidding result information.

In this way, the round-repeat management unit 107 stores therein the number of times of the round, and increments it by one at each round, and when the counted number of times of the round reaches the upper limit, i.e., the predetermined number of times, the round-repeat management unit 107 terminates the processing not to execute any more round. The upper limit can be described by a creator of the application program in the source code of the application program, or can be specified directly or indirectly by a user from a terminal. The termination ensures that the bidding is to be finished within a predetermined time. Whether the rounds are finished is notified as additional information when the bidding result information is notified to the processing units that make bids.

5. Operation of Apparatus as a Whole

In the resource management apparatus as described above, the radar-information displaying application 45 in the node 2 runs by obtaining the radar information form the radar-signal processing application 53, by appropriately setting a parameter such as a predetermined amount to be increased or decreased by the bid-price calculating unit 104.

FIGS. 15 and 16 are tables of presenting states of bids and successful bids made by the resource management apparatus 101 up to the round number “20”. In FIGS. 15 and 16, an example of data of bidding in consecutive 20 rounds is shown. Because the number of times of round repeat is three times, the rounds 1 to 3 indicate a process and a result of the first bidding processing, and the rounds 4 to 6 indicate a process and a result of the second bidding processing. Likewise, in the third round, bidding processing in a unit-time of processing is performed.

As described above, FIGS. 15 and 16 is an example of a case where processing is performed under the following conditions: in terms of relation between supply and consumption of a resource, the radar-signal processing applications 43 and 53 needs 135% of the CPU use rate to create 100% of the radar information; the sonar-signal processing applications 44 and 54 needs 90% of the CPU use rate to create 100% of the sonar information; the radar-information displaying application 45 needs 60% of the CPU use rate to process 100% of the radar information; and the sonar-information displaying application 55 needs 35% of the CPU use rate to process 100% of the sonar information. In this case, when calculating a bid price, four is a very small amount to be increased onto or decreased from a bid price, and three is for a bid volume. In bidding, respective bidders make bids for the four resources, namely, the respective CPU use rates in the nodes 2 and 3, the radar information, and the sonar information, and then contract volumes and contract prices are determined.

In FIGS. 15 and 16, the resources are appropriately allocated from and after the 20th round. Looking at a result in the 20th round, in the node 2, the radar-signal processing application 43 creates 58% of the radar information with 87% of the CPU use rate, and the sonar-signal processing application 44 creates 37% of the sonar information with 42% of the CPU use rate. In the node 3, the radar-signal processing application 53 creates 42% of the radar information with 86% of the CPU use rate, and the sonar-signal processing application 54 creates 63% of the sonar information with 56% of the CPU use rate.

These allocation results satisfy the conditions that the radar-signal processing applications 43 and 53 needs 135% of the CPU use rate to create 100% of the radar information, and the sonar-signal processing applications 44 and 54 needs 90% of the CPU use rate to create 100% of the sonar information. Moreover, the allocation results satisfy the conditions that the radar-information displaying application 45 needs 60% of the CPU use rate, and the sonar-information displaying application 55 needs 35% of the CPU use rate. Furthermore, the radar-information displaying application 45 successfully wins 100% of the radar information in bidding, and the sonar-information displaying application 55 successfully wins 100% of the sonar information in bidding, so that the both application programs obtain respective data required for display without problem. In the rounds before the 20th round, although the resource management apparatus 101 can provisionally operate somehow, there is a possibility that a real time operation in the apparatus as a whole may not be satisfied, because the CPU use rate is not sufficiently allocated to some application programs in some rounds. Nevertheless, it is not a problem in total, because such situation occurs only in early stages of the bidding.

In the first embodiment, because the radar information has a higher priority than the sonar information, the upper limit of a bid price is set to preferentially execute the signal processing and the information display relevant to the radar relative to the signal processing and the information display relevant to the sonar. In the above example, upper limits of a buying price are differentiated between the two sensor-information displaying application programs, and each of the sensor-information displaying application programs runs by buying resources to consume for itself within the upper limit. If setting the upper limit as available to be changed, the priority of each of the application programs can be changed depending on a situation.

In addition, because a bid price of the CPU use rate in the node 3 is lower than that in the node 2, in which a price of the CPU use rate is raised as a result of a successful bid for the CPU use rate won by the radar-information displaying application 45, a bid price (selling price) of the radar information as a resource from the radar-information processing application program in the node 3 is lower than that from the radar-information processing application program in the node 2, so that the radar-information displaying application 45 purchases the radar information from the radar-signal processing application 53, and the radar-signal processing application 53 in the node 3 is operating.

6. Operation if Application Program being Inactive in Part of Nodes

Any of the above operations is performed when the signal processing application programs are activated in both of the nodes 2 and 3. In the following description, operations are explained in a case where the signal processing application program for radar signals is activated only in the node 3, that is, activated is only the radar-signal processing application 53, while the sonar-signal processing application 54 is inactive in the node 2.

In the first embodiment, the logic processing unit and the wrapper are implemented as separate processes. Each of the resource bidding unit is included in the wrapper. For example, each of the logic processing units and each of the wrappers in the radar-signal processing applications 43 and 53 are compiled and linked as separate execution files, and each activated as separate processes. Alternatively, it can be implemented by a method, such as a dynamic link, that the logic processing unit and the wrapper in the same process are still separately activated.

The logic processing unit and the wrapper are not necessarily separated in all application programs. In other words, some of the application programs, for example, an application program that does not consume the memory so much can be activated collectively at power-up by implementing the logic processing unit and the wrapper as one.

A function of the wrapper is explained below. The wrappers 43c, 44c, 53c, and 54c receive processing requests to the respective corresponding application programs, namely, the radar-signal processing application 43, the sonar-signal processing application 44, the radar-signal processing application 53, and the sonar-signal processing application 54; and are activated even if the logic processing unit of each of the application programs is inactive.

Each of the wrappers activates the logic processing unit of the corresponding application program when the application program gains the resource, and transfers a processing request to the activated logic processing unit.

As described above, each of the wrappers includes the resource bidding unit that makes a bid for the resource for the corresponding application program. If the logic processing unit is inactive, each of the resource bidding units makes a bid at a bid price higher than a selling price when the logic processing unit is active. The state of the logic processing unit whether active or inactive is determined by referring to information that indicates an activation state, and is stored in a memory. After the logic processing unit is activated, each of the resource bidding units makes a bid by calculating a bid price according to the usual calculation method.

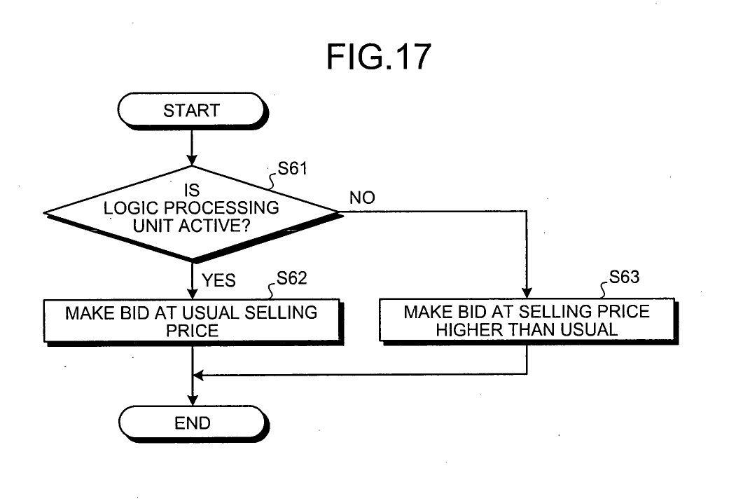

An example of a flow of bid dividing processing performed by the resource bidding unit is explained below with reference to FIG. 17.

To begin with, the resource bidding unit determines whether the logic processing unit is active by referring to information that indicates an activation state stored in a memory (step S61). If the logic processing unit is active (Yes at step S61), the resource bidding unit makes a bid at a usual selling price (step S62). In other words, the resource bidding unit makes a bid by calculating a bid price in accordance with the procedure described in the flowchart shown in FIG. 6.

By contrast, if the logic processing unit is not active (No at step S61), the resource bidding unit makes a bid at a selling price higher than usual (step S63). In such case, the resource bidding unit makes a bid at a fixed price that is predetermined for each of the application programs as the selling price higher than usual.

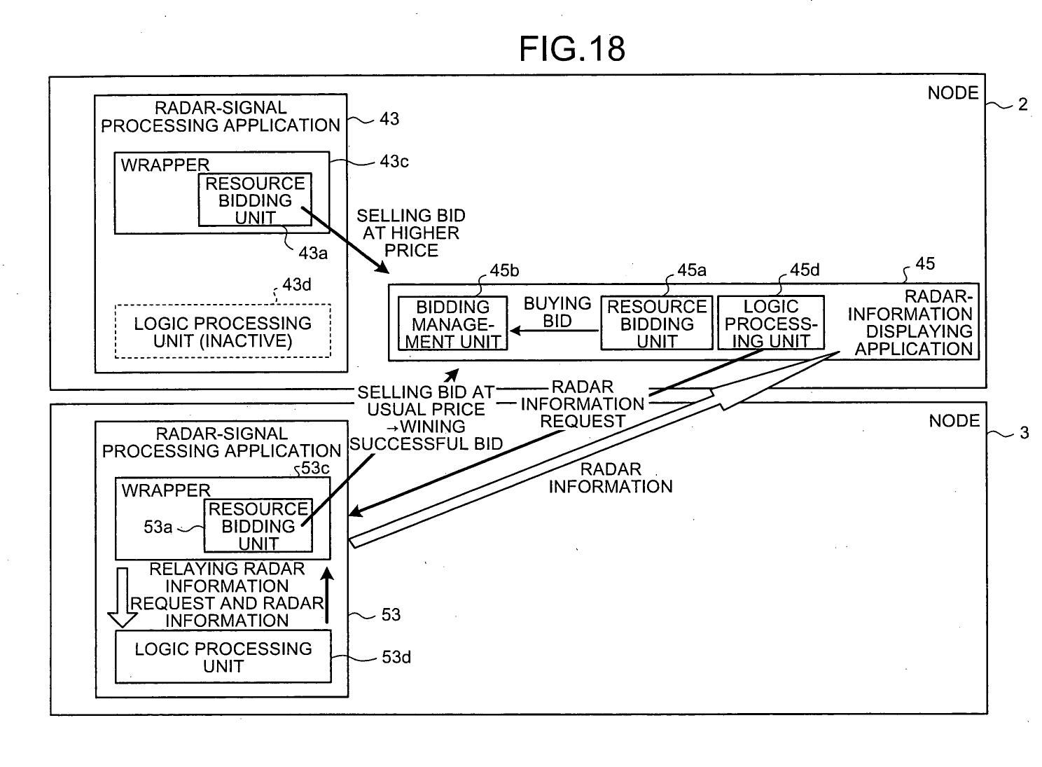

A specific example of the resource management carried out by the nodes 2 and 3, which is the resource management apparatus configured in this way, is explained below. FIG. 18 is a schematic diagram for explaining an operation example when the nodes 2 and 3 both operate normally.

Under the state shown in the figure, the logic processing unit 53d of the radar-signal processing application 53 in the node 3 has been already activated, however, the logic processing unit 43d of the radar-signal processing application 43 in the node 2 is not activated.

As described above, in the bidding for the radar information, the radar-signal processing applications 43 and 53 as the producers each make a selling bid, while the radar-information displaying application 45 as the consumer makes a buying bid. In the bidding, the resource bidding unit 43a, which is in the wrapper 43c of the radar-signal processing application 43 in the node 2, in which the logic processing unit 43d is inactive, makes a bid at a price higher than usual.

On the other hand, the resource bidding unit 53a in the wrapper 53c of the radar-signal processing application 53 in the node 3 makes a bid at a usual selling price. For this reason, other things being equal, the radar-signal processing application 53 wins a successful bid, and then the logic processing unit 53d of the radar-signal processing application 53 in the node 3 operates. Meanwhile, the radar-signal processing application 43 has not won successful bid, as a result, the logic processing unit 43d of the radar-signal processing application 43 in the node 2 is not activated.

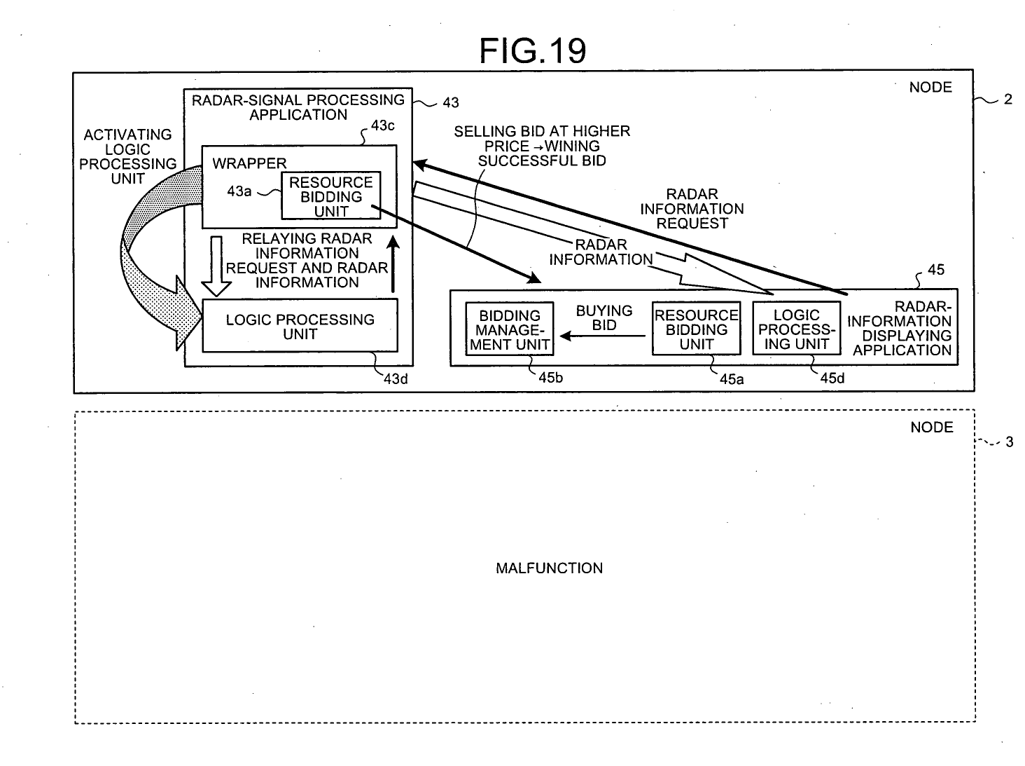

A specific example when a malfunction occurs in the node 3 is explained with reference to FIG. 19.

Under the state shown in the figure, a bidder making a selling bid for the radar information is only the resource bidding unit 43a in the wrapper 43c of the radar-signal processing application 43 in the node 2, so that the resource bidding unit 43a wins a successful bid despite that the selling bid is made at a selling price-higher than usual. When winning the successful bid, the wrapper 43c activates the logic processing unit 43d. For example, if the logic processing unit 43d and the wrapper 43c are implemented as separate processes, a system call is issued from a process performed by the wrapper 43c to activate the logic processing unit 43d as a child process.

In such case, although the radar-information displaying application 45 as a client requests the radar information to the radar-signal processing application 43 as a server, the request is received by the wrapper 43c temporarily. The wrapper 43c transfers the request to the logic processing unit 43d. The logic processing unit 43d creates a radar signal in accordance with the request, and passes the radar signal to the wrapper 43c temporarily. The wrapper 43c transfers the radar signal to the radar-information displaying application 45.

By transferring information in this way, the wrapper 43c itself can be seen as a server from the client, so that the client can make a request to the server without describing processing into the client in consideration of a mixed application program, even if an application program in which the logic processing unit 43d and the wrapper 43c are collectively implemented is present in a mixed manner as described above.

The above description is the operation when a malfunction occurs in the node 3, and a similar operation is taken place if the node 3 turns into an over loaded state due to a rise in the load of another application program.

Thus, according to the first embodiment, the radar-signal processing application 53 in the node 3, which is usually already activated, makes a successful bid and runs, however, if the radar-signal processing application 53 cannot operate due to a malfunction or an overload in the node 3, the radar-signal processing application 43 in the node 2 is newly activated and performs processing.

As described above, because the resource management apparatus 101 can activate an application program only when the application program is required for the resource allocation based on the market mechanism, consumption of the CPU time, a main memory, and a cache memory that are consumed by an activation of an application program can be reduced.

In a resource management apparatus according to a second embodiment, the resource bidding unit is separated into two, namely, a resource bidding unit included in a computer program called as a proxy common to a plurality of application programs, and a resource bidding unit (individual resource-bidding unit) included in each of the application programs; and the former performs bidding by the time when the application programs are activated.

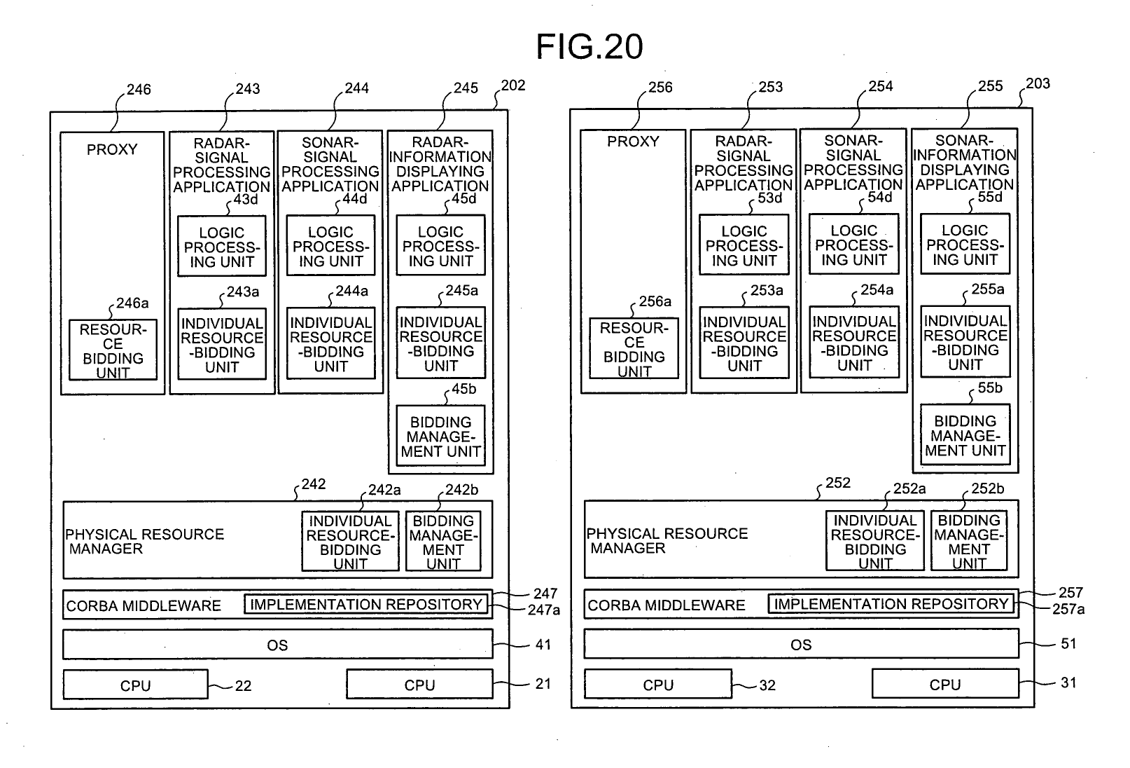

As shown in FIG. 20, a node 202 includes the CPUs 21 and 22, the OS 41, a physical resource manager 242, a radar-signal processing application 243, a sonar-signal processing application 244, a radar-information displaying application 245, a proxy 246, and a CORBA middleware 247.

A node 203 includes the CPUs 31 and 32, the OS 51, a physical resource manager 252, a radar-signal processing application 253, a sonar-signal processing application 254, a sonar-information displaying application 255, a proxy 256, and a CORBA middleware 257.

The node 202 (node 203) in the second embodiment differs from the first embodiment in configuration of the physical resource manager 242 (252), the radar-signal processing application 243 (253), the sonar-signal processing application 244 (254), and the radar-information displaying application 245 (the sonar-information displaying application 255); and differs in being added with the proxy 246 (256) and the CORBA middleware 247 (257). The other configurations and functions are similar to FIG. 2, which is the functional block diagram of configuration of the node 2 (node 3) according to the first embodiment, therefore, the rest of the units are assigned with the same reference numerals as in FIG. 2, and explanations are omitted here.

The node 202 and the node 203 are the resource management apparatuses both of which have the same function, so that each structural element is explained below in detail in the case of the node 202 as an example.

The physical resource, manager 242 differs from the physical resource manager 42 in including an individual resource-bidding unit 242a instead of the resource bidding unit 42a. However, the individual resource-bidding unit 242a differs from the resource bidding unit 42a just in the name, but has the same function. The reason for this is to distinguish the individual resource-bidding unit 242a from a resource bidding unit 246a in the proxy 246, which acts for bids from the application programs.

Similarly, the radar-information displaying application 245 differs from the radar-information displaying application 45 in including an individual resource-bidding unit 245a instead of the resource bidding unit 45a. The individual resource-bidding unit 245a differs from the resource bidding unit 45a just in the name, but has the same function, therefore explanation for it is omitted.

The radar-signal processing application 243 differs from the radar-signal processing application 43 in not including the wrapper 43c but including an individual resource-bidding unit 243a instead of the resource bidding unit 43a. Similarly to the radar-signal processing application 243, the sonar-signal processing application 244 differs from the sonar-signal processing application 44 in not including the wrapper 44c, but including an individual resource-bidding unit 244a instead of the resource bidding unit 44a.

In other words, in the second embodiment, the wrapper 43c (44c), which is activated even if the logic processing unit 43d (44d) is inactive, is not provided, and the individual resource-bidding unit 243a (244a) is activated with the logic processing unit 43d (44d) in a synchronized manner. A function of the individual resource-bidding unit 243a (244a) itself is similar to the resource bidding unit 43a (44a), therefore explanation for it is omitted.

The proxy 246 is a CORBA object, which is activated even when each of the application programs is inactive, and makes a bid in the market as a proxy for the inactive application program, and includes the resource bidding unit 246a.

The resource bidding unit 246a refers to a bid price from each the application programs in an inactive state stored in the proxy 246, and makes a bid at the bid price on behalf of the application program when the application program is inactive.

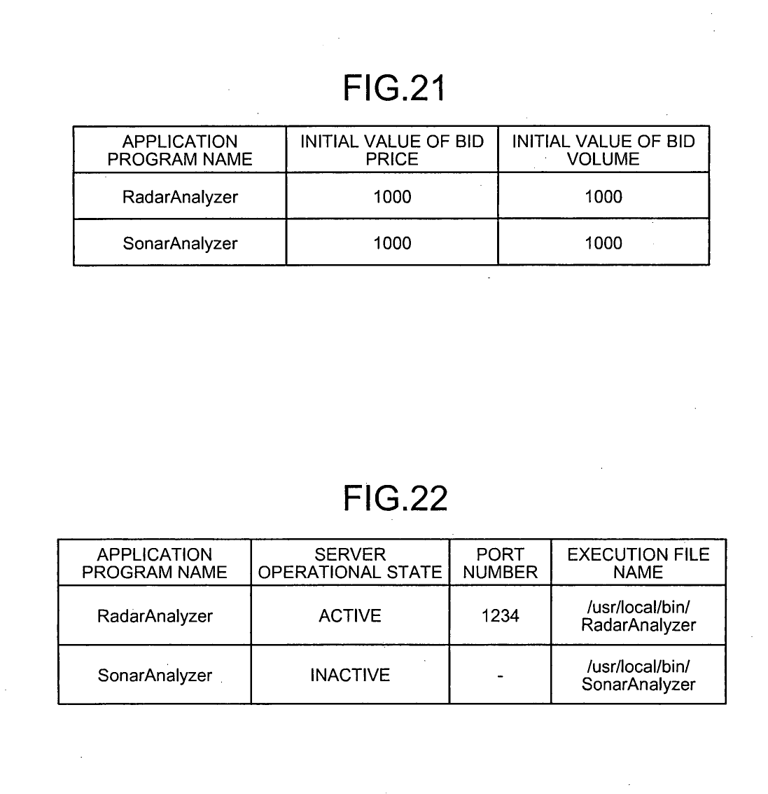

FIG. 21 is a schematic diagram for explaining an example of an application-program bid-information table that contains bid prices made by each of the application programs, and is stored in the proxy 246. As shown in the figure, the application-program bid-information table contains an application program name, an initial value of a bid price made by the application program, and an initial value of a bid volume in an associated manner.

The CORBA middleware 247 is middleware in which CORBA is implemented, and includes an implementation repository 247a. The CORBA is a technical specification of a distributed object made by the Object Management Group (OMG). The reason why including the implementation repository 247a is because it is assumed in the second embodiment to use a mechanism to activate an application program automatically by the implementation repository in the CORBA, which is explained below, when there is a request to an inactive application program.

The implementation repository 247a manages information about an operational state of a server for an application program, precisely, whether the server is in operation, and information about the number of a port through which the server operates if the server is in operation. Moreover, because the implementation repository 247a has a role of activating a server as requested from a client, the implementation repository 247a stores therein information required for activating the server (setting information).

FIG. 22 is a schematic diagram for explaining an example of a setting information table that is stored in the implementation repository 247a, and stores therein setting information for activating an application program. As shown in the figure, the setting information table stores therein an application program name, a server operational state whether active or inactive, a port number, and an execution file name, in an associated manner.

The figure indicates that, for example, the radar-signal processing application (RadarAnalyzer) is in operation through a port numbered “1234” (the server operational state is active), and the execution file is “/usr/local/bin/RadarAnalyzer”. Moreover, the figure indicates that the radar-signal processing application (SonarAnalyzer) is inactive.

The implementation repository 247a activates an application program as requested from a client by referring to the executing file name. In addition, after the application program is activated, the server operational state is changed from inactive to active, and the number of the port (1234) in operation is set in the port number field.

In the second embodiment, the implementation repository 247a executes the application program in a separate process. However, it can be configured such that the application program is executed in the same process to the CORBA middleware.

The use of the proxy 246 is not required for all of the application programs to make a bid before activation. Precisely, some application programs, for example, an application program that does not consume the memory so much can be configured to make a bid by itself from the beginning of power-up by activating the application program collectively when power is turned on.

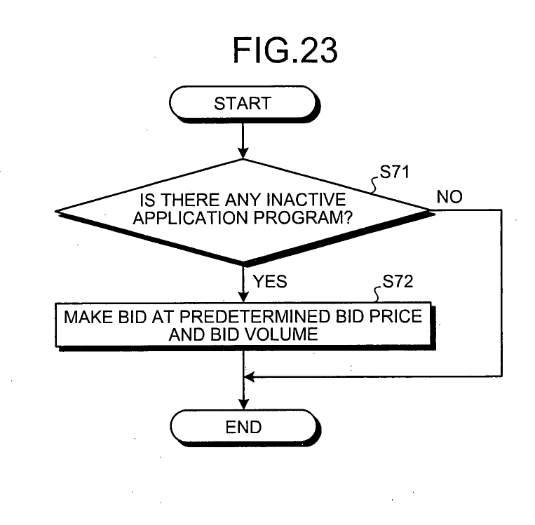

Dividing processing performed by the resource management apparatus according to the second embodiment configured in this way is explained below. FIG. 23 is a flowchart of a general flow of a bid dividing process performed by the resource bidding unit 246a in the proxy 246.

To begin with, the resource bidding unit 246a determines whether there is any inactive application program (step S71). Specifically, the resource bidding unit 246a determines presence of an inactive application program by referring to a server operational state whether active or inactive in the setting information table stored in the proxy 246.

If there is an inactive application program (Yes at step S71), the resource bidding unit 246a acquires a bid price and a bid volume corresponding to the application program from the application-program bid-information table, and makes a bid at the acquired bid price and the bid volume (step S72).

By contrast, if there is no inactive application program (No at step S71), the processing is terminated because there is no need to make a bid on behalf of any application program. In a case of any of the active application programs, the individual resource-bidding unit in each of the active application programs makes a bid.

A specific example of the resource management carried out by the nodes 202 and 203, which is the resource management apparatus configured in this way, is explained below. When the radar-signal processing applications 243 and 253 are active, operations of the nodes 202 and 203 are both similar to those according to the first embodiment.

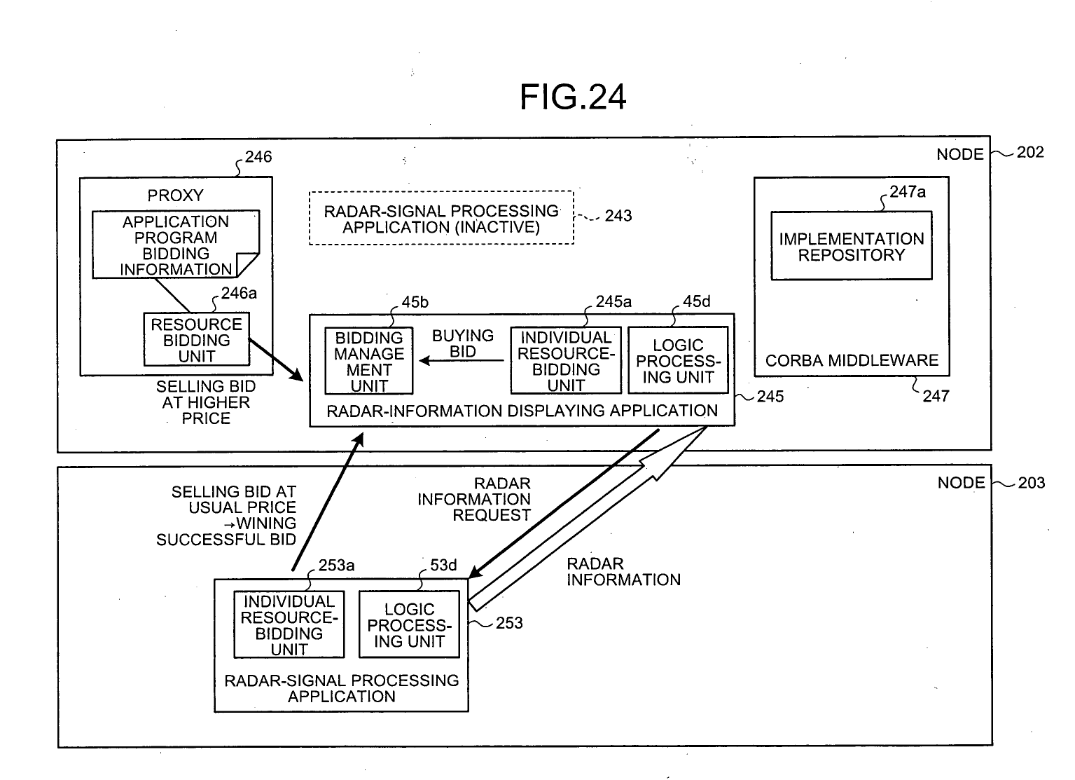

An operation is explained below in a case where the radar-signal processing application 253 is activated only in the node 203, while the radar-signal processing application 243 is not activated in the node 202. FIG. 24 is a schematic diagram for explaining an operation example when the nodes 202 and 203 both operate normally.

In the following description, an example is shown in a case where the proxy 246 acts only for the radar-signal processing application 243 to make a bid, however, if the proxy 246 are responsible for making bids from a plurality of application programs collectively, the proxy 246 stores therein respective bid prices from the application programs.

In a state shown in FIG. 24, the radar-signal processing application 253 in the node 203 has been already activated, meanwhile the radar-signal processing application 243 in the node 202 has not been activated.

As described above, in the bidding for the radar information, the radar-signal processing applications 243 and 253 as the producers each make a selling bid, while the radar-information displaying application 245 as the consumer makes a buying bid. In the bidding, the resource bidding unit 246a of the proxy 246 in the node 202, which acts for the radar-signal processing application 243 in the node 202, which is inactive, makes a bid at a price higher than usual.

On the other hand, the radar-signal processing application 253 in the node 203 makes a bid at a usual selling price. For this reason, other things being equal, the radar-signal processing application 253 wins a successful bid, and then the logic processing unit 53d of the radar-signal processing application 253 in the node 203 operates, meanwhile the logic processing unit 246a of the proxy 246 in the node 202 has not won successful bid. As a result, the radar-signal processing application 243 in the node 202 is not activated.

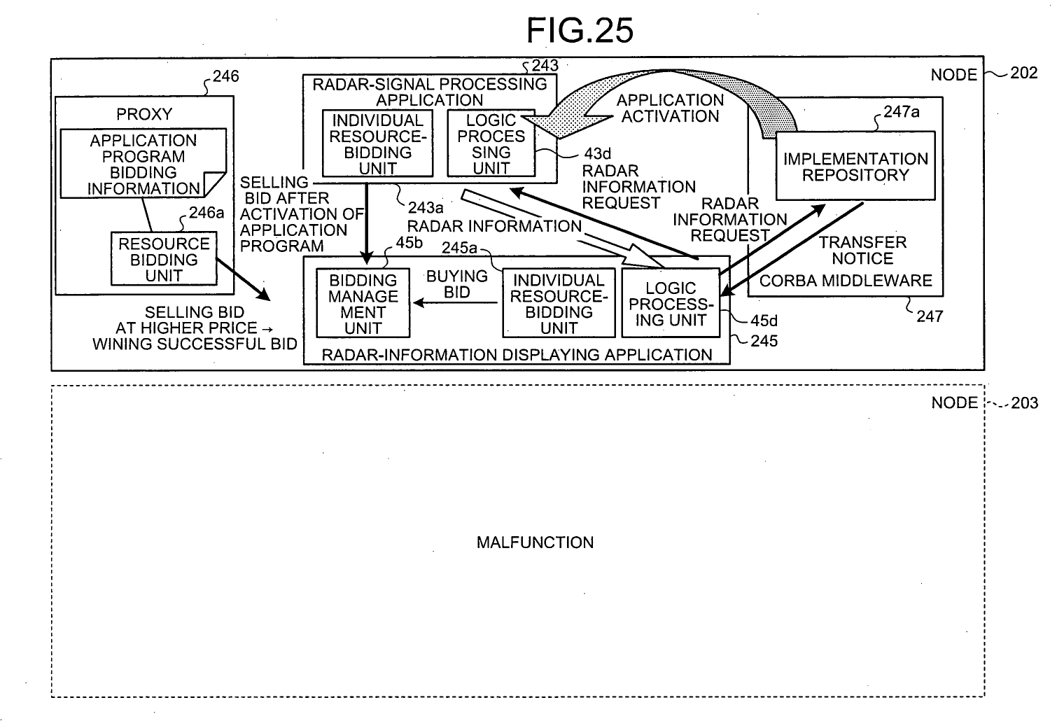

A specific example when a malfunction occurs in the node 203 is explained below with reference to FIG. 25.

A bidder making a selling bid for the radar information is only the proxy 246 in the node 202 as a proxy for the radar-signal processing application 243, so that the resource bidding unit 246a in the proxy 246 wins a successful bid despite that the selling bid is made at a selling price higher than usual.

If the proxy 246 wins a successful bid, the radar-information displaying application 245 as a client requests the radar information to the radar-signal processing application 243 as a server, however, the request is temporarily received by the implementation repository 247a. When the implementation repository 247a receives the request, the implementation repository 247a reads out the server operational state from the setting information table, and recognizes that the radar-signal processing application 243 has not been activated.

The implementation repository 247a then acquires the executing file name form the setting information table, and activates the radar-signal processing application 243. After the activation, the implementation repository 247a replies a transfer notice that includes the port number of the radar-signal processing application 243 that has been activated to the radar-information displaying application 245, which has transmitted the request for the radar information.

When the radar-information displaying application 245 receives the transfer notice, the radar-information displaying application 245 re-transmits the request for the radar information to the radar-signal processing application 243. The transfer mechanism is defined in the rules of CORBA. Therefore, as described above, even if an application program that makes a bid by itself from the beginning of power-up without making a bid before activation by using the proxy 246 is present in a mixed manner, the client can make a request to the server without describing processing into the client in consideration of a mixed application program.

Once the radar-signal processing application 243 has been activated, the individual resource-bidding unit 243a of the radar-signal processing application 243 participates in bidding by itself. It is adequate that the proxy 246 is given with only setting information for making a bid until the application program is activated, for example, respective initial values of the bid price and the bid volume, or a method of calculating the initial values. A more sophisticated function, for example, a fine adjustment of the bid price in accordance with a situation, is to be implemented in the application program itself as required, and to be performed on a bid after the application program is activated.

The above description is the operation when a malfunction occurs in the node 203, and a similar operation is taken place if the node 203 turns into an over loaded state due to a rise in the load of another application program.

In the second embodiment, an embodiment implemented on the implementation repository in CORBA is shown in the above, however, a similar embodiment can be implemented on distributed middleware other than the CORBA middleware, for example, Web service middleware, if an application-program activating mechanism similar to the implementation repository can be used.

In addition, for the purpose of simplification of explanation in the second embodiment, the sensor information system 1 is explained as the system including two of the nodes 202 and 203, however, it can include three or more nodes. Moreover, the radar 5 and the sonar 7 that output sensor signals are connected to the nodes 202 and 203, respectively, however, a plurality of devices each of which outputs a sensor signal can be configured to be connected to a single node. In other words, among the nodes, a node to which no device for outputting a sensor signal is connected can be present, and a node to which the devices each for outputting a sensor signal are connected can be present.

Furthermore, in the second embodiment, each of the nodes is provided with two CPUs, however, it can be provided with a single CPU, or three or more CPUs. In such case, one or a plurality of CPUs is connected to another circuit with a bus inside each of the nodes.

In this way, according to the second embodiment, the radar-signal processing application 253 that is already activated in the node 203 usually runs by making a successful bid, however, if the radar-signal processing application 253 cannot operate due to a malfunction or an overload in the node 203, the radar-signal processing application 243 in the node 202 can be newly activated and perform processing.

Thus, the resource management apparatus according to the second embodiment can reduce consumption of the CPU time, the main memory, and the cash memory required by activation of application programs in accordance with the resource allocation based on the market mechanism.

In addition, according to the second embodiment, deferring from the first embodiment, activation is carried out by using an existing mechanism for general purpose, such as the implementation repository in the CORBA, so that activation by a wrapper is not required, consequently the number of development processes can be suppressed. Moreover, a call to an application program is made directly to the application program, so that there is no need to relay the call to the logic processing unit like the wrapper.

In the second embodiment, two exemplary embodiments, using wrappers or proxies, are shown in the above. However, the present invention is not limited to the embodiments described above. Various alterations or modifications can be made within a scope not changing the concept of the present invention.

For example, an embodiment intermediate between the above two embodiments can be implemented such that a proxy activates an application program, but the application program is directly called not via the proxy. Furthermore, although in the second embodiment, the individual resource-bidding unit in an application program makes a bid after the application program is activated, it can be configured such that the resource bidding unit in the proxy makes a bid from each application program after the application program is activated.

Moreover, the steps in each of the procedures in the second embodiment can be changed in order, some of the steps can be simultaneously executed, or the steps can be executed in different order in each execution, as long as without departing from characteristics of the steps.

A resource management program to be executed by the resource management apparatus according to the first and second embodiments is recorded and provided in an installable or executable file format on a computer-readable recording medium such as compact disk read only memory (CD-ROM), a flexible disk (FD), a compact disk recordable (CD-R), or a digital versatile disk (DVD).

Alternatively, the resource management program can be provided from a computer which stores therein the resource management program and is connected to a network, such as the Internet, by downloading via the network. The resource management program can otherwise be provided or distributed through the network such as the Internet.

Moreover, the resource management program can be provided in a form being incorporated in the ROM in advance.

The resource management program to be executed by the resource management apparatus according to the first and second embodiments has module configuration that includes each unit described above (such as the logic processing unit, the wrapper, the resource bidding unit, the bidding management unit, and the proxy). As practical hardware, each of the units is configured to be loaded and created on the main memory as the CPU 51 (processor) reads out the resource management program from the recording medium, and executes the program.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for allocating a resource, the apparatus comprising:
a discriminating unit that discriminates each of a plurality of application programs into one of an active application program or an inactive application program;
a bid-price calculating unit that calculates a bid price indicating a virtual price of a resource in a bidding to be a value at which the resource is to be preferentially allocated to the active application program rather than the inactive application program; and
a bidding management unit that allocates the resource to each of the application programs based on the bid price calculated by the bid-price calculating unit.

2. The apparatus according to claim 1, wherein
the bid-price calculating unit calculates the bid price of the inactive application program to be larger than the bid price of the active application program, and
the bidding management unit allocates the resource preferentially to an application program that has a bid price smaller than that of another application program.

3. The apparatus according to claim 1, wherein the bid-price calculating unit is provided as a plurality of units, each of which is provided correspondingly to each of the application programs, and calculates the bid price of the corresponding application program among the application programs.

4. The apparatus according to claim 1, further comprising an activating unit for activating an application program, wherein the activating unit is provided correspondingly to each of the application programs among the application programs and activates the corresponding application program, when the corresponding application program is not active and the resource is allocated to the corresponding application program.

5. The apparatus according to claim 4, wherein the activating unit further receives a processing request for the activated corresponding application program, and transfers the received processing request to the activated corresponding application program.

6. The apparatus according to claim 1, wherein the bid-price calculating unit is provided as a single unit for the application programs, and calculates respective bid prices of the corresponding application programs.

7. The apparatus according to claim 6, wherein the bid-price calculating unit takes a predetermined initial value as the bid price of an inactive application program among the corresponding application programs.

8. The apparatus according to claim 6, further comprising an activating unit for activating an application program, wherein the activating unit receives a processing request for an application program to which the resource is allocated among the application programs, and activates the application program for which a process is requested by the processing request, when the application program for which a process is requested by the processing request is not activated.

9. The apparatus according to claim 6, further comprising an activating unit for activating an application program, wherein the activating unit is provided correspondingly to the bid-price calculating unit and activates an application program to which the resource is allocated, when the application program is not activated.

10. The apparatus according to claim 8, further comprising an individual bid-price calculating unit that is provided correspondingly to each of the application programs, activated when the corresponding application program is activated, and calculates the bid price of the corresponding application program.

11. The apparatus according to claim 9, further comprising an individual bid-price calculating unit that is provided correspondingly to each of the application programs, activated when the corresponding application program is activated, and calculates the bid price of the corresponding application program.

12. A computer program product having a computer readable medium including programmed instructions for determining allocation of a resource for each of a plurality of application programs to consume or supply within a predetermined unit-time based on a bidding, wherein the instructions, when executed by a computer, cause the computer to perform:
discriminating between an active application program and an inactive application program among the application programs;
calculating a bid price indicating a virtual price of the resource in the bidding to be a value at which the resource is to be preferentially allocated to the active application program rather than the inactive application program; and
allocating the resource to each of the application programs based on the bid price calculated in the calculating.
